(19) United States
(12) Patent Application Publication
(10) Pub. No.: US 2019/0036739 A1
(43) Pub. Date: Jan. 31, 2019

(54) PROTECTION OF RANGING SOUNDING FROM PREFIX REPLAY ATTACKS

(71) Applicant: QUALCOMM Incorporated, San Diego, CA (US)

(72) Inventors: Erik David Lindskog, Cupertino, CA (US); Ning Zhang, Saratoga, CA (US); Xiaoxin Zhang, Sunnyvale, CA (US); Alireza Raissinia, Monte Serreno, CA (US); Naveen Kumar Kakani, Irving, TX (US)

(21) Appl. No.: 16/046,599

(22) Filed: Jul. 26, 2018

Related U.S. Application Data
(60) Provisional application No. 62/539,497, filed on Jul. 31, 2017.

(51) Int. Cl. H04L 25/02; H04L 5/00; H04L 27/26; H04L 9/08; H04L 29/06

(52) U.S. Cl. CPC H04L 25/0224; H04L 5/0055; H04L 63/0428; H04L 9/0819; H04L 27/2605

(57) ABSTRACT

Methods, systems, and devices for wireless communication are described. A ranging message procedure may employ protection by modifying a cyclic prefix of the ranging message to prevent an attacking device from transmitting a time-advanced copy of the cyclic prefix during symbol of the copied signal. For example, the modified cyclic prefix may include pseudo random training sequences or a set of zero-value symbols. The receiving device may determine a channel estimation technique that accounts for the modified cyclic prefix. The wireless devices performing the ranging measurement process may determine a modulation and coding scheme (MCS) for the ranging message. The wireless devices may negotiate an MCS value and cyclic prefix configuration for the ranging measurement process. In some examples, the ranging message be encoded by applying a sequence of phase rotations or amplitude variations to the base sequence used to generate the sounding training signal.

### CROSS REFERENCES

The present Application for Patent claims benefit of U.S. Provisional Patent Application No. 62/539,497 by Lindskog et al., entitled “PROTECTION OF RANGING SOUNDING FROM PREFIX REPLAY ATTACKS,” filed Jul. 31, 2017, assigned to the assignee hereof, and expressly incorporated by reference in its entirety.

### BACKGROUND

The following relates generally to wireless communication, and more specifically to protection of ranging sounding from prefix replay attacks.

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include wireless fidelity (Wi-Fi) systems, fourth generation (4G) systems such as a Long Term Evolution (LTE) systems or LTE-Advanced (LTE-A) systems, and fifth generation (5G) systems which may be referred to as New Radio (NR) systems, among others. These systems may employ technologies such as code division multiple access (CDMA), time division multiple access (TDMA), frequency division multiple access (FDMA), orthogonal frequency division multiple access (OFDMA), discrete Fourier transform-spread-OFDM (DFT-S-OFDM), Institute of Electrical and Electronics Engineers (IEEE) 802.11 (Wi-Fi), or IEEE 802.16 (WiMAX). A wireless multiple-access communications system may include a number of base stations or network access nodes, each simultaneously supporting communication for multiple communication devices, which may be otherwise known as user equipment (UE).

A device within a wireless communications system may benefit from knowledge of the distance between itself and other devices of interest. In some cases, this knowledge may be enabled through the use of round trip time (RTT) computations. For example, two devices may transmit time-stamped signals that allow one or both of the devices to compute a distance based on propagation time of the signals. In some cases, however, an attacker may interfere with the RTT computations by mimicking a transmission or otherwise impacting the RTT computations. For example, an attacker may mimic aspects of a signal and then transmit a time-advanced copy of the mimicked signal to trick a second device into determining that the device with which it is attempting to communicate is closer than it actually is.

### SUMMARY

The described techniques relate to improved methods, systems, devices, or apparatuses that support protection of ranging sounding signals or ranging messages from attacks, such as physical level attacks. Generally, the described techniques provide for protection mechanisms for training signals between wireless devices when performing ranging measurement processes. For example, a ranging message may be protected by modifying a cyclic prefix of the ranging message. In some cases, the modified cyclic prefix may include a gap interval, a set of null values, a pseudo random training sequence, or a set of zero-modulated sample symbols, among other configurations.

In some examples, the transmitting device may transmit a zero-value base band signal during the time duration for the cyclic prefix. The receiving device may determine a channel estimation technique that accounts for the set of zero-values or pseudo random set of values, or any other configurations for the modified cyclic prefix. The wireless devices performing the ranging measurement process may determine a modulation and coding scheme (MCS) for the ranging message. The wireless device may negotiate an MCS value and cyclic prefix configuration before or at the beginning of the ranging measurement process. In some examples, the MCS for one or more signals of the ranging measurement process may be predetermined or preconfigured (for example as defined by a standard or specification according to which the system operates). In some examples, the ranging message may employ protection by using an encoding scheme that applies a sequence of phase rotations or amplitude variations to the base sequence used to generate the sounding training signal. Additionally or alternatively, amplitude variations may be applied to the sounding training signal. In such cases, a receiver (such as a receiving wireless device) may receive an indication of the phase rotations or amplitude variations, or both, that are then applied to a channel estimate used for a sounding ranging estimation with the transmitter (such as a transmitting wireless device). In some examples, the indication of the phase rotations may be signaled to the receiver after a long training field (LTF) of the sounding training signal. In some instances, the indication of the variation may be predetermined by the two endpoints based on a protocol used to negotiate an encryption key for the exchange. Accordingly, peer devices (such as attacker devices) may not be able to obtain information associated with the encoding schemes used for the transmission of the sounding training signals until after transmission of the sounding training signal has been completed, and also may not be able to interfere with the sounding ranging estimation between the transmitter and the receiver.

A method of wireless communication is described. The method may include identifying a ranging measurement signal including a cyclic prefix for transmission to a wireless device, generating a modified ranging measurement signal including a modified cyclic prefix for transmission in a ranging measurement frame, where the modified cyclic prefix is not a repeated portion of the modified ranging measurement signal, and transmitting the modified ranging measurement signal in the ranging measurement frame. In some cases, the method may include identifying a ranging measurement frame including a symbol prefix for transmission to a wireless device, determining a modified symbol prefix for the ranging measurement frame based on a repeated portion of the symbol prefix, generating a signal for transmission in the ranging measurement frame, the generated signal including the modified symbol prefix, and transmitting the ranging measurement frame that includes the generated signal.

An apparatus for wireless communication is described. The apparatus may include means for identifying a ranging measurement signal including a cyclic prefix for transmission to a wireless device, means for generating a modified ranging measurement signal including a modified cyclic prefix for transmission in a ranging measurement frame, where the modified cyclic prefix is not a repeated portion of the modified ranging measurement signal, and means for transmitting the modified ranging measurement signal in the ranging measurement frame. In some cases, the apparatus may include means for identifying a ranging measurement frame including a symbol prefix for transmission to a wireless device, means for determining a modified symbol prefix for the ranging measurement frame based on a repeated portion of the symbol prefix, means for generating a signal for transmission in the ranging measurement frame, the generated signal including the modified symbol prefix, and means for transmitting the ranging measurement frame that includes the generated signal.

Another apparatus for wireless communication is described. The apparatus may include a processor, memory in electronic communication with the processor, and instructions stored in the memory. The instructions may be operable to cause the processor to identify a ranging measurement signal including a cyclic prefix for transmission to a wireless device, generate a modified ranging measurement signal including a modified cyclic prefix for transmission in a ranging measurement frame, where the modified cyclic prefix is not a repeated portion of the modified ranging measurement signal, and transmit the modified ranging measurement signal in the ranging measurement frame. In some cases, the instructions may be operable to cause the processor to identify a ranging measurement frame including a symbol prefix for transmission to a wireless device, determine a modified symbol prefix for the ranging measurement frame based on a repeated portion of the symbol prefix, generate a signal for transmission in the ranging measurement frame, the generated signal including the modified symbol prefix, and transmit the ranging measurement frame that includes the generated signal.

A non-transitory computer readable medium for wireless communication is described. The non-transitory computer-readable medium may include instructions operable to cause a processor to identify a ranging measurement signal including a cyclic prefix for transmission to a wireless device, generate a modified ranging measurement signal including a modified cyclic prefix for transmission in a ranging measurement frame, where the modified cyclic prefix is not a repeated portion of the modified ranging measurement signal, and transmit the modified ranging measurement signal in the ranging measurement frame. In some cases, the non-transitory computer-readable medium may include instructions operable to cause a processor to identify a ranging measurement frame including a symbol prefix for transmission to a wireless device, determine a modified symbol prefix for the ranging measurement frame based on a repeated portion of the symbol prefix, generate a signal for transmission in the ranging measurement frame, the generated signal including the modified symbol prefix, and transmit the ranging measurement frame that includes the generated signal.

In some examples of the method, apparatus, and non-transitory computer-readable medium described above, the cyclic prefix includes a repeated portion of the ranging measurement signal, and where the modified cyclic prefix includes a gap interval, a zeroed-out cyclic prefix, a set of zero-value-modulated symbols, no transmission, or an unmodulated carrier.

Some examples of the method, apparatus, and non-transitory computer-readable medium described above may further include processes, features, means, or instructions for determining a pseudo random sequence to modulate the cyclic prefix, where the modified cyclic prefix includes a sequence of symbols modulated with the pseudo random sequence.

Some examples of the method, apparatus, and non-transitory computer-readable medium described above may further include processes, features, means, or instructions for determining a set of zero-value samples, where the modified symbol prefix consists of a set of zero-value-modulated sample symbols corresponding to the set of zero-value samples.

In some examples of the method, apparatus, and non-transitory computer-readable medium described above, the modified symbol prefix includes a gap interval that includes a sequence of zero modulated sample symbols.

Some examples of the method, apparatus, and non-transitory computer-readable medium described above may further include processes, features, means, or instructions for identifying a restricted MCS for the ranging measurement frame, where the ranging measurement frame may be transmitted according to the restricted MCS.

Some examples of the method, apparatus, and non-transitory computer-readable medium described above may further include processes, features, means, or instructions for negotiating a value for the restricted MCS based on a ranging operation.

Some examples of the method, apparatus, and non-transitory computer-readable medium described above may further include processes, features, means, or instructions for determining a modified set of modulated symbols for the modified cyclic prefix that may be different than a set of modulated symbols of the cyclic prefix. In some cases, the modified set of modulated symbols are used to replace a repetition of the cyclic prefix.

Some examples of the method, apparatus, and non-transitory computer-readable medium described above may further include processes, features, means, or instructions for determining a modified set of modulated sample symbols that may be different than a set of modulated sample symbols of the symbol prefix and used to replace a repetition of the symbol prefix at an end of the ranging measurement frame.

Some examples of the method, apparatus, and non-transitory computer-readable medium described above may further include processes, features, means, or instructions for encrypting a channel estimation training sequence of the ranging measurement frame, where the transmitted ranging measurement frame includes the encrypted channel estimation training sequence.

Some examples of the method, apparatus, and non-transitory computer-readable medium described above may further include processes, features, means, or instructions for performing a medium reservation operation based on transmission of the encrypted channel estimation training sequence, where the medium reservation operation includes a medium access control (MAC) layer signaling technique.

Some examples of the method, apparatus, and non-transitory computer-readable medium described above may further include processes, features, means, or instructions for transmitting a request-to-send (RTS) message including network allocation vector (NAV) timing information. Some examples of the method, apparatus, and non-transitory computer-readable medium described above may further include processes, features, means, or instructions for receiving, in response to the RTS message, a clear-to-send (CTS) message, where transmitting the ranging measurement frame may be based on the CTS message.

Some examples of the method, apparatus, and non-transitory computer-readable medium described above may further include processes, features, means, or instructions for transmitting, before transmission of the ranging measurement frame, an encryption key corresponding to the encrypted channel estimation training sequence.

In some examples of the method, apparatus, and non-transitory computer-readable medium described above, the encrypted channel estimation training sequence includes a long training field (LTF).

Some examples of the method, apparatus, and non-transitory computer-readable medium described above may further include processes, features, means, or instructions for receiving, from the wireless device, a second ranging measurement frame that includes encryption information for a ranging measurement acknowledgement (ACK) frame. Some examples of the method, apparatus, and non-transitory computer-readable medium described above may further include processes, features, means, or instructions for encrypting a channel estimation field of the ranging measurement ACK frame based on the encryption information.

Some examples of the method, apparatus, and non-transitory computer-readable medium described above may further include processes, features, means, or instructions for transmitting the ranging measurement ACK frame in response to the ranging measurement frame.

Some examples of the method, apparatus, and non-transitory computer-readable medium described above may further include processes, features, means, or instructions for encoding a channel estimation field of the ranging measurement frame, where the transmitted ranging measurement frame includes the encoded channel estimation field.

Some examples of the method, apparatus, and non-transitory computer-readable medium described above may further include processes, features, means, or instructions for establishing a ranging negotiation session with the wireless device. Some examples of the method, apparatus, and non-transitory computer-readable medium described above may further include processes, features, means, or instructions for determining, during the ranging negotiation session, an encryption key for the ranging measurement frame, where the channel estimation field may be encoded based on the encryption key.

Some examples of the method, apparatus, and non-transitory computer-readable medium described above may further include processes, features, means, or instructions for transmitting, during the ranging negotiation, an indication of the encryption key to the wireless device.

In some examples of the method, apparatus, and non-transitory computer-readable medium described above, the encryption key may be determined based on a master key and a previously received measurement or measurement feedback frame.

Some examples of the method, apparatus, and non-transitory computer-readable medium described above may further include processes, features, means, or instructions for conveying channel estimation field encoding information in a field subsequent to the channel estimation field of the ranging measurement frame.

In some examples of the method, apparatus, and non-transitory computer-readable medium described above, the channel estimation field encoding information may be included in at least one of a high throughput (HT) packet extension (PE), very HT (VHT) PE, a high efficiency (HE) PE, or any combination thereof.

Some examples of the method, apparatus, and non-transitory computer-readable medium described above may further include processes, features, means, or instructions for conveying channel estimation field encoding information in a frame subsequent to transmission of the ranging measurement frame.

Some examples of the method, apparatus, and non-transitory computer-readable medium described above may further include processes, features, means, or instructions for updating the cyclic prefix with a set of null data values, where the generated signal may be based on updating the cyclic prefix with the set of null data values.

In some examples of the method, apparatus, and non-transitory computer-readable medium described above, the ranging measurement frame includes an orthogonal frequency division multiplexing (OFDM) signal. In some examples of the method, apparatus, and non-transitory computer-readable medium described above, the ranging measurement signal includes an OFDM signal.

In some examples of the method, apparatus, and non-transitory computer-readable medium described above, the ranging measurement frame includes a fine timing measurement (FTM) signal, a null data packet (NDP), or an ACK signal.

In some examples of the method, apparatus, and non-transitory computer-readable medium described above, the symbol prefix includes one of a short cyclic prefix or a long cyclic prefix.

A method of wireless communication is described. The method may include receiving, from a wireless device, a ranging measurement signal in a ranging measurement frame including a cyclic prefix, where the cyclic prefix is a zeroed-out cyclic prefix or a sequence of symbols modulated with a pseudo random sequence, determining a channel estimation technique that accounts for the zeroed-out cyclic prefix or the sequence of sample symbols modulated with the pseudo random sequence, and estimating a channel from the ranging measurement frame based on the channel estimation technique. In some cases, the method may include receiving, from a wireless device, a ranging measurement frame including a symbol prefix that includes a set of modulated sample symbols, the set of modulated sample symbols consisting of a set of zero-value-modulated sample symbols or a sequence of symbols modulated with a pseudo random sequence, determining a channel estimation technique that accounts for the set of zero-value-modulated sample symbols or the sequence of sample symbols modulated with the pseudo random sequence, and estimating a channel from the ranging measurement frame based on the channel estimation technique.

An apparatus for wireless communication is described. The apparatus may include means for receiving, from a wireless device, a ranging measurement signal in a ranging measurement frame including a cyclic prefix, where the cyclic prefix is a zeroed-out cyclic prefix or a sequence of symbols modulated with a pseudo random sequence, means for determining a channel estimation technique that accounts for the zeroed-out cyclic prefix or the sequence of sample symbols modulated with the pseudo random sequence, and means for estimating a channel from the ranging measurement frame based on the channel estimation technique. In some cases, the apparatus may include means for receiving, from a wireless device, a ranging measurement frame including a symbol prefix that includes a set of modulated sample symbols, the set of modulated sample symbols consisting of a set of zero-value-modulated sample symbols or a sequence of symbols modulated with a pseudo random sequence, means for determining a channel estimation technique that accounts for the set of zero-value-modulated sample symbols or the sequence of sample symbols modulated with the pseudo random sequence, and means for estimating a channel from the ranging measurement frame based on the channel estimation technique.

Another apparatus for wireless communication is described. The apparatus may include a processor, memory in electronic communication with the processor, and instructions stored in the memory. The instructions may be operable to cause the processor to receive, from a wireless device, a ranging measurement signal in a ranging measurement frame including a cyclic prefix, where the cyclic prefix is a zeroed-out cyclic prefix or a sequence of symbols modulated with a pseudo random sequence, determine a channel estimation technique that accounts for the zeroed-out cyclic prefix or the sequence of sample symbols modulated with the pseudo random sequence, and estimate a channel from the ranging measurement frame based on the channel estimation technique. In some cases, the instructions may be operable to cause the processor to receive, from a wireless device, a ranging measurement frame including a symbol prefix that includes a set of modulated sample symbols, the set of modulated sample symbols consisting of a set of zero-value-modulated sample symbols or a sequence of symbols modulated with a pseudo random sequence, determine a channel estimation technique that accounts for the set of zero-value-modulated sample symbols or the sequence of sample symbols modulated with the pseudo random sequence, and estimate a channel from the ranging measurement frame based on the channel estimation technique.

A non-transitory computer readable medium for wireless communication is described. The non-transitory computer-readable medium may include instructions operable to cause a processor to receive, from a wireless device, a ranging measurement signal in a ranging measurement frame including a cyclic prefix, where the cyclic prefix is a zeroed-out cyclic prefix or a sequence of symbols modulated with a pseudo random sequence, determine a channel estimation technique that accounts for the zeroed-out cyclic prefix or the sequence of sample symbols modulated with the pseudo random sequence, and estimate a channel from the ranging measurement frame based on the channel estimation technique. In some cases, the non-transitory computer-readable medium may include instructions operable to cause a processor to receive, from a wireless device, a ranging measurement frame including a symbol prefix that includes a set of modulated sample symbols, the set of modulated sample symbols consisting of a set of zero-value-modulated sample symbols or a sequence of symbols modulated with a pseudo random sequence, determine a channel estimation technique that accounts for the set of zero-value-modulated sample symbols or the sequence of sample symbols modulated with the pseudo random sequence, and estimate a channel from the ranging measurement frame based on the channel estimation technique.

In some examples of the method, apparatus, and non-transitory computer-readable medium described above, the zeroed-out cyclic prefix includes a gap interval, a set of zero-value-modulated symbols, no transmission, or an unmodulated carrier, or any combination thereof.

Some examples of the method, apparatus, and non-transitory computer-readable medium described above may further include processes, features, means, or instructions for estimating the channel includes modeling the channel as a finite impulse response (FIR) filter and determining a system of equations based on the FIR filter.

Some examples of the method, apparatus, and non-transitory computer-readable medium described above may further include processes, features, means, or instructions for estimating the channel further includes performing a least squares operation using the system of equations.

Some examples of the method, apparatus, and non-transitory computer-readable medium described above may further include processes, features, means, or instructions for receiving a channel estimation training sequence from the ranging measurement frame, where the channel estimation training sequence may be encrypted using an encryption key.

Some examples of the method, apparatus, and non-transitory computer-readable medium described above may further include processes, features, means, or instructions for establishing a ranging negotiation session with the wireless device. Some examples of the method, apparatus, and non-transitory computer-readable medium described above may further include processes, features, means, or instructions for determining, during the ranging negotiation session, the encryption key for the ranging measurement frame. Some examples of the method, apparatus, and non-transitory computer-readable medium described above may further include processes, features, means, or instructions for decrypting the channel estimation training sequence based on the encryption key.

Some examples of the method, apparatus, and non-transitory computer-readable medium described above may further include processes, features, means, or instructions for identifying an encoded channel estimation field of the ranging measurement frame. Some examples of the method, apparatus, and non-transitory computer-readable medium described above may further include processes, features, means, or instructions for receiving channel estimation encoding information in a field subsequent to the channel estimation field. Some examples of the method, apparatus, and non-transitory computer-readable medium described above may further include processes, features, means, or instructions for decoding the channel estimation field based on the channel estimation encoding information.

In some examples of the method, apparatus, and non-transitory computer-readable medium described above, the channel estimation field encoding information may be included in at least one of an HT PE, VHT PE, an HE PE, or any combination thereof. In some examples of the method, apparatus, and non-transitory computer-readable medium described above, the cyclic prefix includes one of a short cyclic prefix or a long cyclic prefix.

In some examples of the method, apparatus, and non-transitory computer-readable medium described above, the ranging measurement frame includes an FTM signal, an NDP, or an ACK signal.

### BRIEF DESCRIPTION OF THE DRAWINGS

FIG. 1 illustrates an example of a wireless communication system that supports protection of ranging sounding from prefix replay attacks in accordance with aspects of the present disclosure.

FIG. 2 illustrates an example of a process flow that supports protection of ranging sounding from prefix replay attacks in accordance with aspects of the present disclosure.

FIG. 3 illustrates an example of a process flow that supports protection of ranging sounding from prefix replay attacks in accordance with aspects of the present disclosure.

FIGS. 4A through 4C illustrate examples of cyclic prefix configurations that support protection of ranging sounding from prefix replay attacks in accordance with aspects of the present disclosure.

FIG. 5 illustrates an example of a process flow that supports protection of ranging sounding from prefix replay attacks in accordance with aspects of the present disclosure.

FIGS. 6 through 8 show block diagrams of a device that supports protection of ranging sounding from prefix replay attacks in accordance with aspects of the present disclosure.

FIG. 9 illustrates a block diagram of a system including a station (STA) that supports protection of ranging sounding from prefix replay attacks in accordance with aspects of the present disclosure.

FIGS. 10 through 12 show block diagrams of a device that supports protection of ranging sounding from prefix replay attacks in accordance with aspects of the present disclosure.

FIG. 13 illustrates a block diagram of a system including a base station that supports protection of ranging sounding from prefix replay attacks in accordance with aspects of the present disclosure.

FIGS. 14 through 17 illustrate methods for protection of ranging sounding from prefix replay attacks in accordance with aspects of the present disclosure.

### DETAILED DESCRIPTION

Devices within a wireless communications system may benefit from knowledge of the distance between themselves and other devices of interest. In some cases, this knowledge may be enabled through the use of round trip time (RTT) computations. For example, two devices (for example utilizing wireless local area network (WLAN) communications or wireless wide area network (WWAN) communications) may transmit time-stamped signals that allow one or both of the devices to compute a distance based on propagation time of the signals. In some cases, however, an attacker (such as another wireless device) may interfere with the RTT computations by mimicking a transmission or otherwise impacting the RTT computations. For example, an attacker may record a repeated section of a transmission (such as a short cyclic prefix or long cyclic prefix of an orthogonal frequency division multiplexed (OFDM) symbol) and transmit a time-advanced copy of the recorded signal to trick a second device into determining that the device with which it is attempting to communicate is closer than it is in reality. In some examples, the time-advanced transmission of a recorded, repeated signal may be referred to as a cyclic prefix replay attack. Protections against such attacks may be desired to prevent impersonation and various other problems.

As described, various physical (PHY) layer protection schemes may be used alone or in any combination to combat potential attacks. For example, cyclic prefixes in a ranging message may be modified to prevent being recorded and reused by an attacker. The ranging message may be a ranging measurement signal transmitted in a ranging measurement frame used for channel estimation. In some examples, a cyclic prefix may be zeroed out (for example, replaced with an unmodulated carrier) such that an attacking device may not record any useful information. Additionally or alternatively, a device may transmit pseudorandom training data (such as pseudorandom modulated sample symbols) for the cyclic prefix. An attacking device may record the pseudorandom training data, but later parts of the training signal may not reuse the pseudorandom training data, preventing a cyclic prefix replay attack. In some cases, a device may not transmit a prefix for symbols in a ranging message. For example, the device may refrain from transmitting during time allotted to a cyclic prefix and may transmit the ranging message with a gap between symbols. Additionally or alternatively, the base sequence used to generate the training symbols for the symbols in the training data may be encoded with phase rotations and/or amplitude variations. Different encodings of the base sequence may be used for generating the symbols in the training data and may be used to make each training symbol different. Further, the encoding of the training symbols may be different from packet to packet. The variation of the encoding may be performed to deny an attacker any repetition to exploit.

The present disclosure also describes aspects related to negotiating, with a transmitting or receiving device, a cyclic prefix configuration and a modulation and coding scheme (MCS) for ranging messages. For example, the device may negotiate to use a modulation scheme such as quadrature amplitude modulation (QAM), or a specific order of QAM (such as 16-QAM, 64-QAM, 256-QAM, etc.). Additionally or alternatively, different coding rates may be used. In some examples, a device may encode header information of the ranging messages. In some examples, the device may reserve a transmission medium by transmitting a request-to-send (RTS) or clear-to-send (CTS) transmission based on the encoded header information. Further, the device may transmit or receive encryption information for the encoded header information before or after the ranging message, for example to protect the PHY portion of the ranging message.

Aspects of the disclosure are initially described in the context of a wireless communications system. Aspects of the disclosure are then described in the context of process flows and example cyclic prefix configurations. Aspects of the disclosure are further illustrated by and described with reference to apparatus diagrams, system diagrams, and flowcharts that relate to protection of ranging sounding signals from PHY level attacks such as a prefix repeat attack.

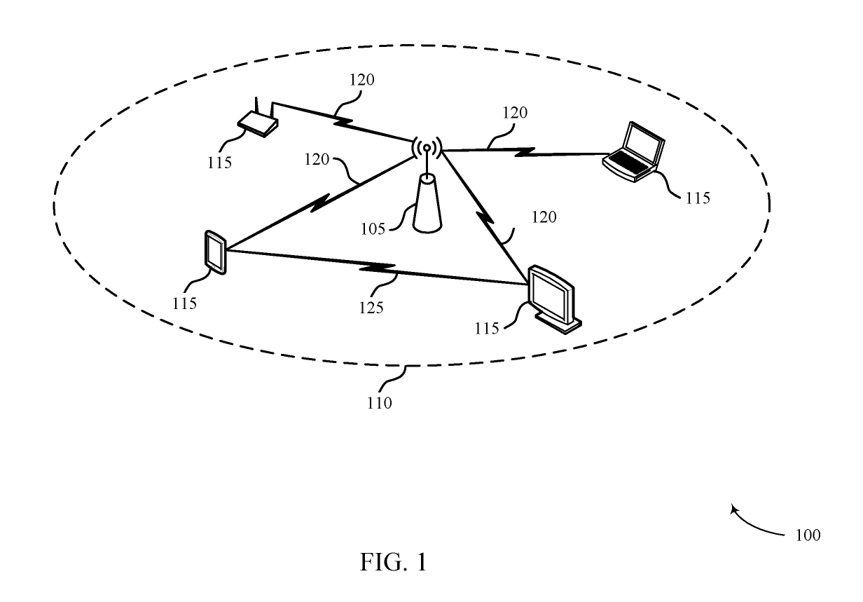

FIG. 1 illustrates a WLAN 100 (also known as a Wi-Fi network) configured in accordance with various aspects of the present disclosure. The WLAN 100 may include wireless devices such as an access point (AP) 105 and multiple associated stations (STAs) 115, which may represent various devices such as mobile stations, personal digital assistant (PDAs), other handheld devices, netbooks, notebook computers, tablet computers, phones, laptops, display devices (such as TVs, computer monitors, etc.), printers, key fobs (for example for passive keyless entry and start (PKES) systems), etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

In some cases, STAs 115 may form networks without APs 105 (or equipment other than the STAs 115 themselves, for example). One example of such networks is an ad hoc network (or wireless ad hoc network). Ad hoc networks may alternatively be referred to as mesh networks or peer-to-peer (P2P) connections. In some cases, ad hoc networks may be implemented within a larger wireless network (such as a WLAN 100). For example, two STAs 115 may communicate via a communication link 125 regardless of whether both STAs 115 are in the same coverage area (served by the same AP 105, for example). In such an ad hoc system, one or more of the STAs 115 may assume the role filled by the AP 105 in a BSS (may coordinate transmissions within the ad hoc network, for example). Such a STA 115 may be referred to as a group owner (GO).

STAs 115 may communicate (such as via communication link 120) according to the WLAN radio and baseband protocol for PHY and medium access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands, such as shared licensed frequency bands, where multiple operators may have a license to operate in the same or overlapping frequency band or bands.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (such as an AP 105) to shape and/or steer an overall antenna beam in the direction of a target receiver (such as a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (or antenna port, for example) such that the desired beamforming effects are achieved. In some cases, these weights may be determined before beamforming can be employed. For example, the transmitter (such as the AP 105) may transmit one or more sounding packets to the receiver in order to determine CSI.

WLAN 100 may further support multiple-input, multiple-output (MIMO) wireless systems. Such systems may use a transmission scheme between a transmitter (such as an AP 105) and a receiver (such as a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (for example, each transmission may be beamformed differently). The receiver (such as a STA 115) may try multiple beams (or, for example, antenna subarrays) while receiving the signals.

While the STAB 115 are capable of communicating with each other through the AP 105 using communication links 120, STAB 115 can also communicate directly with each other via direct wireless communication links 120. Direct wireless communication links can occur between STAB 115 regardless of whether any of the STAB is connected to an AP 105. Examples of direct wireless communication links 120 include Wi-Fi Direct connections, connections established by using a Wi-Fi Tunneled Direct Link Setup (TDLS) link, and other peer-to-peer (P2P) group connections.

WLAN PDUs may be transmitted over a radio frequency spectrum band, which in some examples may include multiple sub-bands. In some cases, the radio frequency spectrum band may have a bandwidth of 80 MHz, and each of the sub-bands may have a bandwidth of 20 MHz. Transmissions to/from STAs 115 and APs 105 oftentimes include control information within a header that is transmitted prior to data transmissions. The information provided in a header is used by a device to decoded the subsequent data. For example, WLAN PDUs may be transmitted over a radio frequency spectrum band, which in some examples may include multiple sub-bands. In some cases, the radio frequency spectrum band may have a bandwidth of 80 MHz, and each of the sub-bands may have a bandwidth of 20 MHz. A legacy WLAN preamble may include legacy short training field (STF) (L-STF) information, legacy LTF (L-LTF) information, and legacy signaling (L-SIG) information. The legacy preamble may be used for packet detection, automatic gain control, channel estimation, etc. The legacy preamble may also be used to maintain compatibility with legacy devices. A packet also may include a payload after the preamble.

High efficiency WLAN preambles can be used to schedule multiple devices, such as STAs 115, for single-user simultaneous transmission (such as single-user orthogonal frequency division multiple access (SU-OFDMA)) and/or MU-MIMO transmissions. In one example, an HE WLAN signaling field may be used to signal a resource allocation pattern to multiple receiving STAs 115. The HE WLAN signaling field includes a common user field that is decodable by multiple STAs 115, the common user field including a resource allocation field. The resource allocation field indicates resource unit distributions to the multiple STAs 115 and indicates which resource units in a resource unit distribution correspond to MU-MIMO transmissions and which resource units correspond to orthogonal frequency division multiple access (OFDMA) single-user transmissions. The HE WLAN signaling field also includes, subsequent to the common user field, dedicated user fields that are assigned to certain STAs 115. The HE WLAN signaling field is transmitted with a WLAN preamble to the multiple STAs 115.

The high efficiency WLAN preamble may include any of a repeated legacy WLAN field (such as an RL-SIG field), a first WLAN signaling field (such as a first high efficiency WLAN signaling field such as HE-SIG-A), a second WLAN signaling field (such as a second high efficiency WLAN signaling field such as HE-SIG-B), a WLAN STF (such as a high efficiency WLAN STF), and at least one WLAN LTF (such as at least one high efficiency WLAN LTF). The high efficiency WLAN preamble may enable an AP 105 to simultaneously transmit to multiple stations (for example using MU-MIMO communications) and may also enable an AP 105 to allocate resources to multiple STAs 115 for uplink/downlink transmissions (for example using SU-OFDMA communications). The high efficiency WLAN preamble may use a common signaling field and one or more dedicated (such as station-specific) signaling fields to schedule resources and to indicate the scheduling to other WLAN devices.

In some cases, aspects of the MIMO transmissions and/or beamformed transmissions may vary based on a distance between transmitter (such as an AP 105) and receiver (such as a STA 115). WLAN 100 may otherwise generally benefit from AP 105 having information regarding the location of the various STAs 115 within coverage area 110. In some examples, relevant distances may be computed using RTT-based ranging procedures.

As an example, WLAN 100 may offer such functionality that produces accuracy on the order of one meter (or even centimeter-level accuracy). The same (or similar) techniques employed in WLAN 100 may be applied across other radio access technologies (RATs). For example, such RTT-based ranging functionality may be employed in developing “relative geofencing” applications (applications where there is a geofence relative to an object of interest such as a mobile device, a car, a person, etc.). Various such examples are considered in accordance with aspects of the present disclosure. For example, car keys may employ RTT estimation for PKES systems. RTT-based geofences around an adult may monitor the position of a child within the geofence. Additionally, drone-to-drone and car-to-car RTT functionality may help prevent collisions.

However, various obstacles to RTT-based functionality may exist. For example, a rogue peer device may impersonate a legitimate one, which may result in RTT “deflation” (or “inflation”) (such that a receiver may measure a range different than an actual range). Accordingly, improved techniques for securing RTT estimation against such attacks (such as against PHY layer attacks on range measurements) may be desired. Although aspects of the present disclosure are described using IEEE 802.11 REV-mc Wi-Fi RTT and IEEE 802.11az ranging solutions as illustrations, it is to be understood that the techniques disclosed herein may be applicable to protecting various measurements (such as an RTT measurement) using any suitable radio access technology (RAT) and any present or future releases thereof.

Various proposals (such as those which may be used alone or in any combination) are described to address PHY level attacks of RTT-based ranging messages. For example, various techniques described herein may inhibit an attacker (such as a rogue peer wireless device) from interfering with RTT-based ranging measures (for example, by copying a part of a ranging packet so as to generate a false range). Generally, the techniques described herein may prevent an attacker from copying a repeated prefix, transmitting the repeated prefix, and tricking a receiver into receiving the repeated prefix (which may, for example, affect the attacked modem's range calculations by tricking it into determining a ranging message transmission has ended earlier than it will in reality). Further, the techniques described herein may easily extend to additional techniques that provide protection of PHY level attacks (such as by combining various aspects of the different methods or adjusting various aspects of the respective methods). One method may include identifying a modified cyclic prefix, generating signal for a ranging message, and transmitting the ranging message with the modified cyclic prefix. In some examples, a set of phase rotations or amplitude variations may be applied to the base LTF sequence. Additionally, the phase rotations may vary between different transmissions of the LTF sequence. Further, aspects may also provide techniques for combining the modified cyclic prefix with phase rotated or encoded LFT symbols. The techniques for modifying and encoding or phase rotating LTF symbols may vary between different LTF symbols or between different packets.

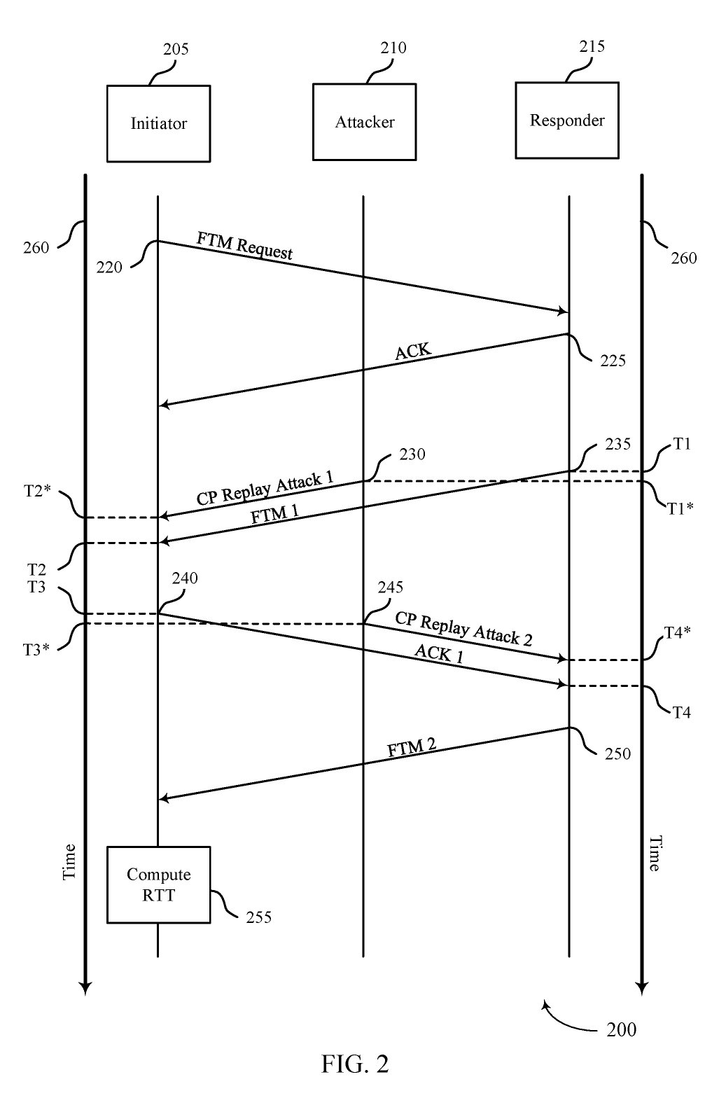

FIG. 2 illustrates an example of a process flow 200 that supports protection of ranging sounding from prefix replay attacks in accordance with various aspects of the present disclosure. In some examples, process flow 200 may implement aspects of wireless communication system 100. For example, aspects of process flow 200 may illustrate a Wi-Fi 802.11 REV-mc RTT measurement protocol. In aspects, the RTT measurement protocol may be based on the sequential exchange of fine timing measurement (FTM) signals between two communicating devices. For each of explanation, time axis 260 has been duplicated and illustrated on each side of process flow 200.

Briefly, the FTM-based RTT protocol may involve initiator 205 sending a FTM request at 220, to which responder 215 transmits an acknowledgement (ACK) at 225. In some examples, these transmissions may be used to establish who is the initiator 205 and/or to ensure that both initiator 205 and responder 215 commit to remaining awake during the subsequent message exchanges. Initiator 205 and responder 215, as well as would-be attacker 210, may each be an example of an AP 105 or STA 115 (or some combination thereof), as described with reference to FIG. 1. At 235, responder 215 may transmit a signal (referred to as FTM 1) at time T1. FTM 1 may be received by initiator 205 at time T2 (and may be timestamped with T2). At 240, initiator 205 may respond with ACK 1 (such as at time T3), which may be received by responder 215 at time T4. Subsequently (for example at 250), responder 215 may send FTM 2, which may contain information about T1 and T4. Using the information included in FTM 2, initiator 205 may compute RTT at 255. For example, the RTT may be computed as ((T2−T1)+(T4−T3))/2. In various examples, the time stamp pairs (T1, T4) and (T2, T3) may be in reference to local clocks of the initiator 205 and responder 215, respectively. In some cases, multiple FTM signals may be exchanged and the RTT may be computed based on some combination of RTTs for the multiple FTM signals. The FTM signals may be OFDM signals including a cyclic prefix. A cyclic prefix may be reused. For example, FTM 1 may have the same cyclic prefix as FTM 2, or a previous FTM not shown. Similarly, ACK 1 may have the same cyclic prefix as a previous ACK transmitted by the Initiator 205.

In some cases, however, an attacker 210 may interfere with this RTT measurement protocol. For example, attacker 210 may attempt to trick initiator 205 into determining that responder 215 is closer than it really is. In aspects, such an attack may be referred to as a Wi-Fi RTT deflation attack (for example, because the attacker is ‘deflating’ the RTT computed at 255). Generally, such RTT deflation may be achieved by decreasing T2 or T4 or increasing T1 or T3, or some combination of these. Accordingly, in some examples, attacker 210 may impersonate one or both of initiator 205 and responder 215. For example, attacker 210 may record at least a portion of a cyclic prefix transmitted by initiator 205 or responder 215 and transmit a time-advanced copy of the cyclic prefix (which may be referred to as a cyclic prefix replay attack) during the portion of the OFDM signal of which the cyclic prefix is a copy. Additionally or alternatively, attacker 210 may produce its own FTM and/or ACK frame, or overlay a measurement part of the FTM and/or ACK frames with a time-advanced training sequence, in whole or in part. Although aspects of the examples herein are described in terms of RTT deflation, it is to be understood that RTT inflation (in which, for example, an attacker inflates the RTT computed at 255) are also considered, among other examples.

For example, at 230, attacker 210 may transmit cyclic prefix Replay Attack 1, which may in some cases transmit a cyclic prefix to the initiator during an FTM transmission (for example, before the cyclic prefix in the FTM signal transmitted by responder 215) at 235. Accordingly, initiator 205 may compute a smaller T2 value (T2*). Additionally or alternatively, the attacker 210 may attack the ACK 1 transmitted at 240 (with cyclic prefix Replay Attack 2 at 245), which may cause the responder 215 to compute a smaller T4 value (T4*). Additional possible attacks are considered, such that these are illustrated for didactic purposes only. In some cases, attacker 210 may perform its attacks under certain time constraints (such as to ensure that a reasonable RTT is computed at 255 and the measurement is not discarded).

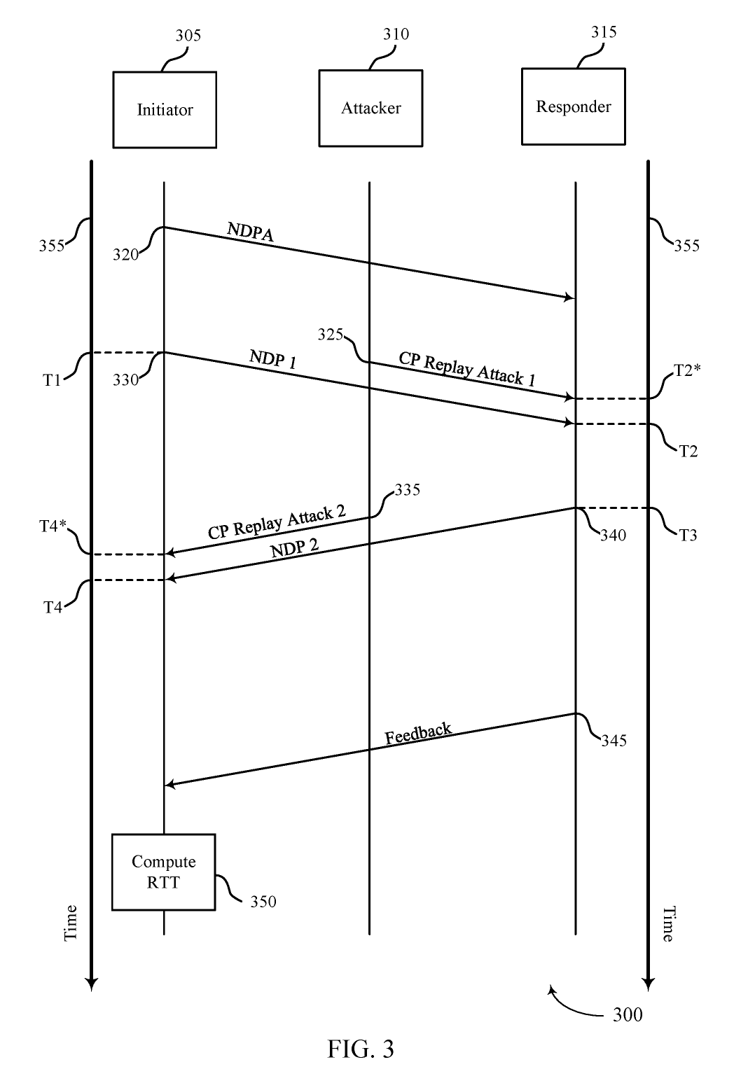

FIG. 3 illustrates an example of a process flow 300 that supports protection of ranging sounding from prefix replay attacks in accordance with various aspects of the present disclosure. In some examples, process flow 300 may implement aspects of wireless communication system 100. For example, aspects of process flow 300 may illustrate the IEEE 802.11az ranging protocol introduced above. That is, the 802.11az ranging protocol (e.g. which may be used for single user (SU) or multi-user (MU) MIMO transmissions) may be based on null data packet (NDP) transmissions, which may be vulnerable to PHY layer attacks. For example, a proposed uplink MU-MIMO ranging sequence for 802.11az may rely on staggered sounding transmissions from the multiple users and/or symbol-interleaved sounding transmissions. In each case, the sounding transmissions may be subject to precise timing control (such as through the use of a trigger frame). Accordingly, an attacker that interrupts this timing control (such as at the PHY layer) may negatively affect the ranging protocol. Similar negative effects on the SU protocol are also considered (and, in some cases, illustrated with reference to process flow 300). Initiator 305 and responder 315, as well as would-be attacker 310, may each be an example of an AP 105 or STA 115, as described with reference to FIG. 1. For ease of explanation, time axis 355 has been duplicated and illustrated on each side of process flow 300.

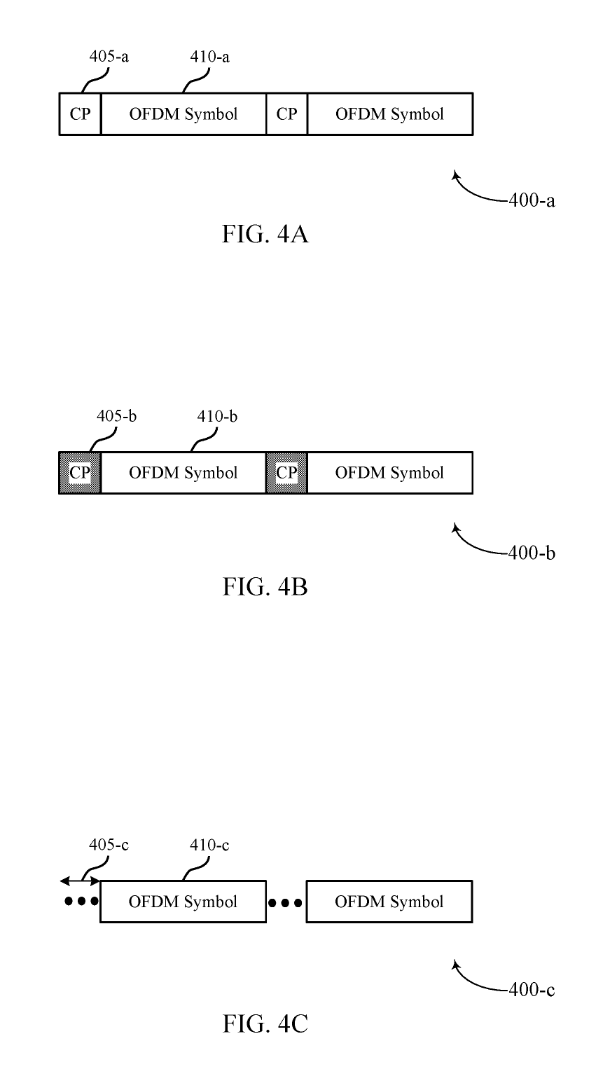

Briefly, the 802.11az SU RTT-based ranging protocol may involve initiator 305 transmitting a NDP announcement (NDPA) at 320. The NDPA may initiate the ranging measurement process by gaining control of the channel (for example, by using any suitable clear channel assessment), including indicating a duration of the channel sounding sequence and identifying the intended responder 315 (or intended responders 315 in the MU case). Subsequently, at 330, initiator 305 may transmit NDP 1 (such as at time T1). In aspects, and as described further with reference to FIG. 4, NDP 1 may allow responder 315 to analyze the training fields to calculate a channel response upon reception at time T2. At time T3, responder 315 may transmit an NDP 2 (at 340), which may be received by initiator 305 at time T4. For example, NDP 1 and NDP 2 may be used to measure the channel response based on the direction of transmission (such as from initiator 305 to responder 315 or from responder 315 to initiator 305). At 345, responder 345 may transmit feedback (such as channel state information (CSI)) to initiator 305, which may enable the initiator 305 to compute RTT at 350. A similar computation may in some cases be performed at responder 315.

In some cases, however, an attacker 310 may interfere with this RTT measurement protocol. For example, attacker 310 may attempt to trick initiator 305 into determining that responder 315 is closer than it really is. In aspects, such an attack may be referred to as a deflation attack (because the attacker is ‘deflating’ the RTT computed at 350, for example). Generally, such RTT deflation may be achieved by decreasing T2 or T4 and/or increasing T1 or T3. Accordingly, in some examples, attacker 310 may impersonate initiator 305 (such as by transmitting a time-advanced, recorded copy of a prefix such as a cyclic prefix or a symbol prefix). Additionally or alternatively, attacker 310 may produce its own NDP frame or overlay the measurement part of the NDP frames with a time-advanced training sequence. Although aspects of the examples herein are described in terms of RTT deflation, it is to be understood that RTT inflation (for example in which an attacker inflates the RTT computed at 350) are also considered.

For example, at 325, attacker 310 may transmit cyclic prefix Replay 1, which may in some cases include a recorded copy of a cyclic prefix included in the NDP 1 transmitted from initiator 305 at 330. Accordingly, responder 315 may compute a smaller T2 value (T2*). Additionally or alternatively, the attacker 310 may attack the NDP 2 transmitted at 340 (with NDP 2 Attack at 335), which may cause the initiator 305 to compute a smaller T4 value (T4*). Additional possible attacks are considered, such that these are illustrated for didactic purposes only. In some cases, attacker 310 may perform its attacks under certain time constraints (for example to ensure that a reasonable RTT is computed at 350 and the measurement is not discarded).

FIGS. 4A through 4C illustrate examples of a modified cyclic prefix configurations 400 that supports protection of ranging sounding from prefix replay attacks in accordance with various aspects of the present disclosure. In some examples, the modified cyclic prefix configurations 400 may implement aspects of wireless communication system 100. For instance, any of the modified cyclic prefix configurations may be performed by initiator or responder devices as described herein. In the example illustrated below, the modified cyclic prefix configurations 400 may be implemented by a device having multiple antennas (such as a MIMO device) that is capable of transmitting multiple OFDM symbols. Devices having a single antenna may also support the modified cyclic prefix configurations 400 of FIGS. 4A through 4C, but may only transmit a single OFDM symbol.

In a nominal ranging message, a prefix (such as a cyclic prefix) may include a sequence of modulated sample symbols which may be a copy of part of the signal transmitted later in the symbol. An attacker device may record the cyclic prefix and transmit the recorded cyclic prefix with a time advance (for example relative to the signal from which the recorded prefix is copied) to the receiving device. Thus, the attacker may trick the receiving device into thinking the transmitting device is closer than in reality. FIG. 4 illustrates a number of cyclic prefix configurations that may prevent these type of attacks.

As shown in FIG. 4A, modified cyclic prefix configuration 400-a includes cyclic prefix 405-a. In some cases, cyclic prefix 405-a is an example of a symbol prefix. Cyclic prefix 405-a may precede OFDM symbol 410-a. Instead of including a portion of OFDM symbol 410-a, cyclic prefix 405-a may include a set of zero-value-modulated sample symbols or a zeroed-out cyclic prefix. Thus, an attacking device may record cyclic prefix 405-a, but may not be able to use the recorded copy to accurately reproduce a subsequent portion of the true symbol. Cyclic prefix 405-a may be an example of a modified cyclic prefix.

In another example, modified cyclic prefix configuration 400-b may include cyclic prefix 405-b, as shown in FIG. 4B. Cyclic prefix 405-a may precede OFDM symbol 410-b. Instead of including a section of OFDM symbol 410-b, cyclic prefix 405-b may include a sequence of symbols modulated with a pseudo random sequence. Thus, an attacking device may record cyclic prefix 405-b, but may not be able to use the recorded copy to accurately reproduce a subsequent portion of the true symbol.

In FIG. 4C, modified cyclic prefix configuration 400-c includes cyclic prefix 405-c, which may be a symbol prefix. Cyclic prefix 405-c may preceding OFDM symbol 410-c. Instead of including a portion of OFDM symbol 410-c, cyclic prefix 405-c may be unmodulated or empty. In such examples, the carrier used for transmission according to the modified cyclic prefix configuration 400-c may be unused during the duration of cyclic prefix 405-c (thereby transmitting zero modulated symbols during the period of the cyclic prefix, for example). An attacking device may not be able to record cyclic prefix 405-c, and thus may not be able to use a recorded copy to accurately reproduce a subsequent portion of the true symbol.

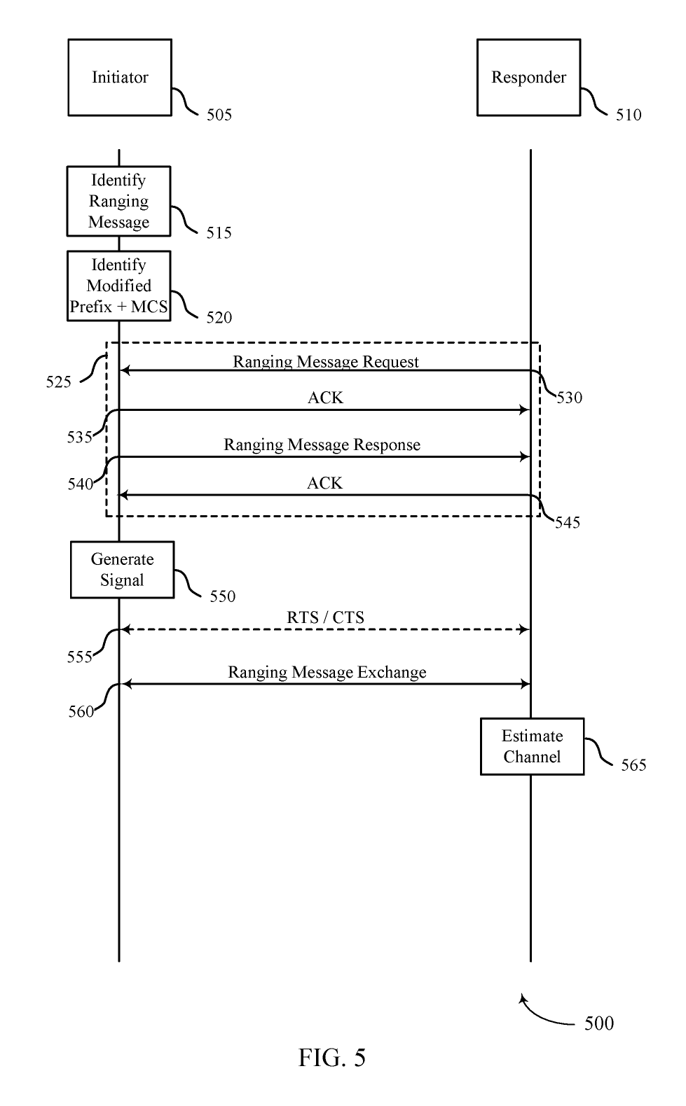

FIG. 5 illustrates an example of a process flow 500 that supports protection of ranging sounding from prefix replay attacks in accordance with various aspects of the present disclosure. In some examples, process flow 500 may implement aspects of wireless communication system 100. Process flow 500 illustrates identifying a modified prefix (such as a modified cyclic prefix) and MCS, negotiating the modified prefix and MCS, and transmitting a ranging message based on the modified prefix and MCS for the protection of ranging measurement processes between transmitter 505 and receiver 510.

At 515, the transmitter 505 may identify a ranging measurement signal including a cyclic prefix for transmission to a wireless device. In some examples, the ranging measurement signal in a ranging measurement frame may be referred to as a ranging message. In some cases, the ranging message may be used for channel estimation. In some examples, the ranging measurement signal may be an example of an OFDM signal. Additionally or alternatively, the ranging measurement signal may include an FTM signal, an NDP, or an ACK signal. In some examples, the cyclic prefix may include a short cyclic prefix or a long cyclic prefix. In some examples, if the transmitter 505 were to transmit the ranging message with the original cyclic prefix, the transmitter 505 may be susceptible to a prefix replay attack by an attacking device. Thus, the transmitter 505 may transmit a modified prefix in the ranging message instead.

At 520, the transmitter 505 may identify the modified prefix and an MCS level for the ranging message. For example, cyclic prefixes in a ranging message may be modified to prevent being recorded and reused by an attacker. In some examples, the transmitter 505 may identify the modified prefix and MCS level based on a predetermined modified cyclic prefix configuration, or the transmitter 505 may determine a modified prefix and MCS level. For example, the transmitter 505 may determine a set of zero-value-modulated samples, where the modified cyclic prefix includes a set of zero-value-modulated sample symbols corresponding to the set of zero-value samples. In another example, determining the modified sample symbols may include determining a pseudo random sequence to modulate the cyclic prefix, where the modified cyclic prefix includes a sequence of symbols modulated with the pseudo random sequence. Additionally the pseudo random sequence used to modulate the cyclic prefix may vary from symbol to symbol, from ranging message to ranging message, or some combination thereof. Additionally or alternatively, the modified cyclic prefix may include a gap interval that includes a sequence of zero modulated sample symbols.

In some cases, an MCS for a ranging message with a modified cyclic prefix may be set to a lower value. For example, the transmitter 505 or receiver 510 may set (for example, lower) the MCS for FTM frames or ACK frames. In some examples, the FTM frames and ACK frames may comply with a protocol defined by a standard such as current or future 802.11REVmc protocol. In some examples, an MCS may be set for an FTM frame such that the corresponding ACK frame has the same or lower MCS value. In some examples, demodulating a signal with a modified cyclic prefix may result in a lower signal to noise ratio (SNR), for example due to a degraded channel estimate. By lowering the MCS value, the receiver 510 may demodulate payloads of the ranging message even with a degraded channel estimate and lower SNR.

In some cases, devices participating in the ranging protocol may negotiate the type of modified cyclic prefix to use as well as an MCS level restriction during a negotiation duration 525. At 530, the transmitter 505 may transmit a ranging message request, and the receiver 510 may transmit an ACK in response at 535. In some implementations, the receiver 540 may transmit a ranging message response at 540 and receive an ACK in response to the ranging message response at 545. The ranging message request and ranging message response may be used to indicate or negotiate configurations for an RTT measurement protocol.

For example, at the beginning of an FTM-based RTT measurement protocol, the transmitter 505 may transmit an FTM request to the receiver 510, and the receiver 510 may transmit an FTM response to the transmitter 505 in response. The transmitter 505 and receiver 510 may negotiate a cyclic prefix configuration and MCS level restriction in the FTM request and FTM response. In some examples, FTM frames, such as the FTM request frame and FTM response frame, may include an additional element or field for negotiating configurations. In one example, the transmitter 505 may include a sequence of bits in the additional field of an FTM request signal to indicate using pseudorandom training data for a cyclic prefix during the FTM-based RTT measurement protocol. The additional field of the FTM request signal may also indicate an MCS configuration. The receiver 510 may receive the FTM request, determine whether to negotiate the indicated configurations, and transmit an FTM response signal to the transmitter 505. In some examples, the FTM response signal may include the additional field to further negotiate the cyclic prefix configuration or the MCS configuration.

In some examples, the transmitter 505 and receiver 510 may negotiate additional configurations for MAC level security, PHY level security, or both. In some examples, the PHY level security negotiation may include determining whether to encode an LTF of the ranging message and use a modified cyclic prefix, or whether to encode the LTF but not use a modified cyclic prefix, among other configurations. Additionally or alternatively, the transmitter 505 and receiver 510 may negotiate which configuration of a modified cyclic prefix to use. For example, negotiating MAC security configurations may include conveying a key used to encode an LTF prior to transmitting the encoded LTF in the ranging message. In some examples, configuring the MAC level security may include generating a master key for security and content in a frame exchange (such as the ranging message request and ranging message response at 530 and 540 respectively). The transmitter 505 and receiver 510 may establish the master key at the beginning of the ranging protocol (such as during the negotiation duration 525). In some cases, the transmitter 505 and receiver 510 may determine a key for a frame based on the master key and the content of a previous, successfully received (such as an ACK received) frame. Thus, the content of the frame remains available. In some examples, the previous frame may not have been received successfully. In such cases, the most recent successfully received frame content may be used to determine the encryption key. Additionally or alternatively, the encryption key generation sequence may be restarted based on the measurement of a successfully received frame after a sequence of one or more lost frames. Additionally or alternatively, the content used to generate the encryption key may be encrypted. In some examples, when a frame containing content to be used for key generation is not acknowledged by the receiving modem, the next content used to generate a new key may be transmitted in an unencrypted, or otherwise decodable, fashion.

Further, an encryption key used for encoding at least a portion of an LTF symbol (such as a channel estimation field of an LTF symbol) may be generated or determined based on any previously received frame. The previously received frame may be a ranging measurement frame (such as an FTM frame or an NDP frame) or a ranging measurement feedback frame (such as an FTM frame or any other frame containing ranging measurement feedback). In some examples, the encryption key may be any previously received frame (such as a frame having variable content) or a frame received that is configured according to a predetermined standard (such as a current 802.11REVmc standard, a future 802.11REVmc standard, an 802.11az standard, or any other 802.11 standard). In some examples, feedback messages (such as ACK or NACK messages) may be transmitted in response to the frames and contain information used for generating the encryption key. The feedback messages may be received by the device conveying or generating the encryption key so that the device is able to determine whether the encryption key was successfully conveyed.

In some implementations, the ranging protocol may be based on ranging NDP transmissions. The transmitter 505 and the receiver 510 may similarly negotiate security configurations (such as PHY security, MAC security, or both) at the beginning of the ranging protocol (for example, during the negotiation duration). In some examples, negotiation in an NDP-based RTT measurement protocol may be based on an NDPA, NDP transmissions, or both. For example, the receiver 510 may determine that an NDP transmission may be decoded by the master key based on an NDPA. In some examples, the key for an encoding of an LFT used for a ranging measurement may be conveyed in a packet extension (PE). For instance, a key may be conveyed in a PE for NDP packets transmitted from either the initiator device or responder device. In some examples, the PE field may be modulated as a legacy part of the packet such that the PE field may be demodulated using the channel estimate from the legacy LTF.

In some examples, encryption keys for LTFs may be signaled without a PE field. For example, a key for an NDP frame transmitted by a responding device (such as receiver 510) may be generated based on some contents of a previous ranging measurement feedback frame, or another previous frame transmitted from the responder to the initiator. Additionally or alternatively, the key for an NDP frame transmitted by the initiator device (such as transmitter 505) may be generated from some contents of a previous ranging measurement feedback frame, or another previous frame from the responder to the initiator. In some examples, a frame containing contents used for key generation may not receive an ACK, and the key generating scheme may be recovered based on a previous, successfully received frame. In some cases, when a frame containing content for key generation is lost, a new key may be generated from a new (such as a following) frame with unencrypted, or otherwise decodable, content, such as not to risk reusing an old key.

At 550, transmitter 505 may generate a signal for transmission in the ranging message, the signal including the modified cyclic prefix. For example, the transmitter 505 may replace at least a portion of the cyclic prefix with at least a portion of the modified cyclic prefix to generate the signal. In some examples, the transmitter 505 may update the cyclic prefix with a set of null data values, where the signal is generated based on updating the cyclic prefix with the set of null data values.

In some examples, the transmitter 505 may encrypt header information of the ranging message. For example, sounding training signals or a channel estimation training sequence of the ranging message frame may be encoded. For example, the header information may be encoded to include a sequence of phase rotations, amplitude variations, or cyclic shifts to protect the sounding training signal from peer devices. To remain secure, the encoding of the LTF sequence may be changed from use to use, such that the encoding cannot be reused. In some examples, cyclic prefixes of OFDM symbols in an LTF may be configured as a modified cyclic prefix, the contents of the modified cyclic prefix including zeros or pseudorandom training data, among other configurations discussed herein.

In some cases, encoding information associated with a LTF may be transmitted before the LTF is transmitted (during the negotiation duration 525, for example). In some examples, encryption information for a following FTM frame or ACK frame (such as FTM/ACK frame n) may be included in a current FTM frame (such as FTM frame n+1). In another example, header encoding information for a frame may be conveyed after the LTF is transmitted. For example, a PE in a subsequent frame may include encoding information for the LTF. In some examples, the PE may be an example of a high throughput (HT) PE, a very high throughput (VHT) PE, or a high efficiency (HE) PE.

In the case of an NDP-based ranging process, the measurement report frame used to convey the measurement made on a previous NDP frame may be used to determine the encryption used for a following NDP sequence (such as the frame transmitted during the measurement phase). If the measurement report frame is lost, the last successfully received frame content may be used, or the sequence may be reset to start the sequence of the encryption of the NDP frame. Alternatively, some unencrypted, or otherwise decodable content, in a new frame may be used to generate a new key.

In some examples, MAC header information may be demodulated with an encoded LTF channel estimate. Thus, other wireless devices in the wireless communications system may be unable to read network allocation vector (NAV) information included in the MAC header. To avoid transmission interference, a device may reserve the transmission medium at the MAC level by a MAC layer signaling technique. For example, the medium may be reserved by the RTS/CTS transmissions at 555. In some examples, the RTS/CTS may be unencrypted, such that neighboring devices may identify appropriate NAV information. In some examples, the initiating device may perform RTS/CTS when at risk of an attacking device and refrain from RTS/CTS, and refrain from encoding the LTF and modifying the LTF cyclic prefixes, when an attacking device is not present or deemed a risk.

At 560, the transmitter 505 may transmit the ranging message to the receiver 510. The receiver 510 may receive the ranging message and begin channel estimation based on the ranging message at 565. For example, the receiver 510 may determine a channel estimation technique that accounts for the set of zero-values or the pseudo random set of values in the cyclic prefix. The receiver 510 may then estimate a channel from the ranging message based on the channel estimation technique. In some examples, the receiver 510 may model the channel as a finite impulse response (FIR) filter and determine a system of equations based on the FIR filter. The receiver 510 may then estimate the channel by performing a least squares operation using the system of equations. In some examples, a PE may be transmitted with the ranging message. The receiver 510 may demodulate the PE and, in some examples, decode the ranging message based on the PE. The receiver 510 may then perform a sounding estimation

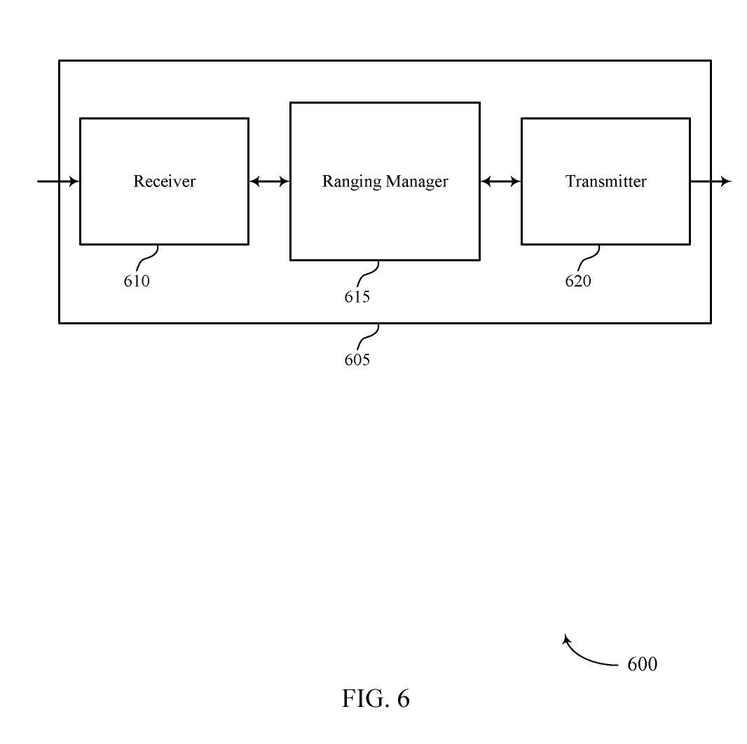

FIG. 6 shows a block diagram 600 of a wireless device 605 that supports protection of ranging sounding from prefix replay attacks in accordance with aspects of the present disclosure. Wireless device 605 may be an example of aspects of an initiator as described herein. Wireless device 605 may include receiver 610, ranging manager 615, and transmitter 620. Wireless device 605 may also include a processor. Each of these components may be in communication with one another (such as via one or more buses).

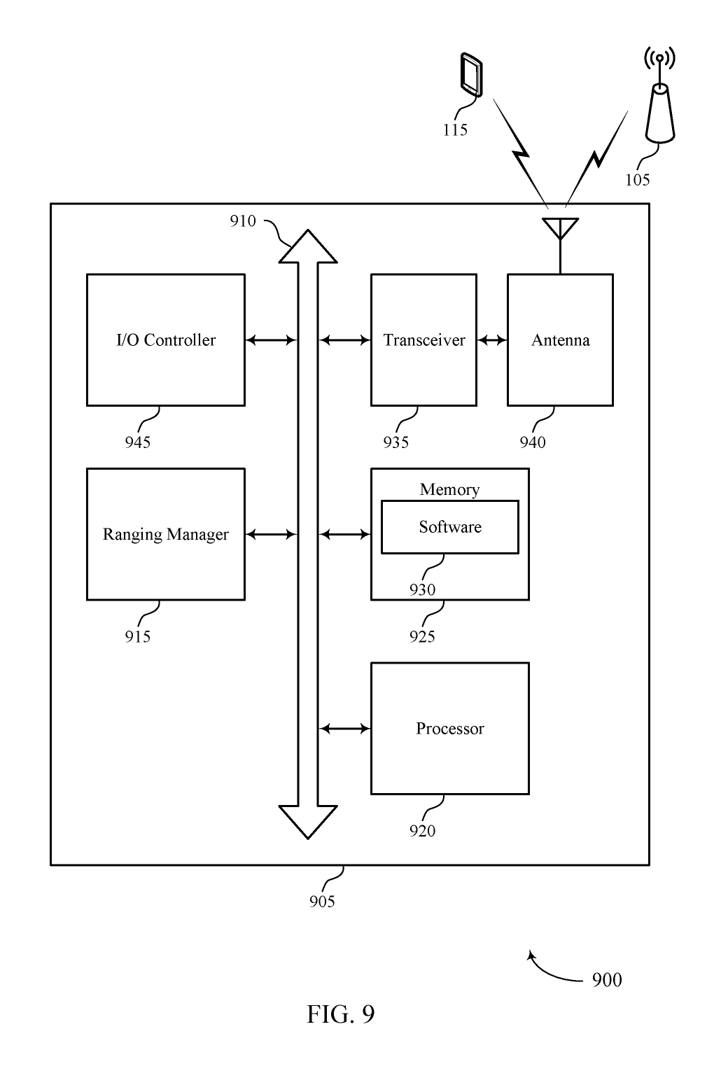

Receiver 610 may receive information such as packets, user data, or control information associated with various information channels (such as control channels, data channels, and information related to protection of ranging sounding from prefix replay attacks, etc.). Information may be passed on to other components of the device. The receiver 610 may be an example of aspects of the transceiver 935 described with reference to FIG. 9. The receiver 610 may utilize a single antenna or a set of antennas.

Ranging manager 615 may be an example of aspects of the ranging manager 915 described with reference to FIG. 9. Ranging manager 615 and/or at least some of its various sub-components may be implemented in hardware, software executed by a processor, firmware, or any combination thereof. If implemented in software executed by a processor, the functions of the ranging manager 615 and/or at least some of its various sub-components may be executed by a general-purpose processor, a digital signal processor (DSP), an application-specific integrated circuit (ASIC), an field-programmable gate array (FPGA) or other programmable logic device (PLD), discrete gate or transistor logic, discrete hardware components, or any combination thereof designed to perform the functions described in the present disclosure.

The ranging manager 615 and/or at least some of its various sub-components may be physically located at different locations, including being distributed such that portions of functions are implemented at different physical locations by one or more physical devices. In some examples, ranging manager 615 and/or at least some of its various sub-components may be a separate and distinct component in accordance with various aspects of the present disclosure. In other examples, ranging manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Ranging manager 615 may identify a ranging measurement frame including a cyclic prefix for transmission to a wireless device. Ranging manager 615 may generate a ranging measurement signal including a modified cyclic prefix for transmission in a ranging measurement frame, where the modified cyclic prefix is not a repeated portion of the modified ranging measurement signal. The ranging manager 615 may transmit the modified ranging measurement signal in the ranging measurement frame. In some example, a symbol prefix may be an example of a cyclic prefix.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may utilize a single antenna or a set of antennas.

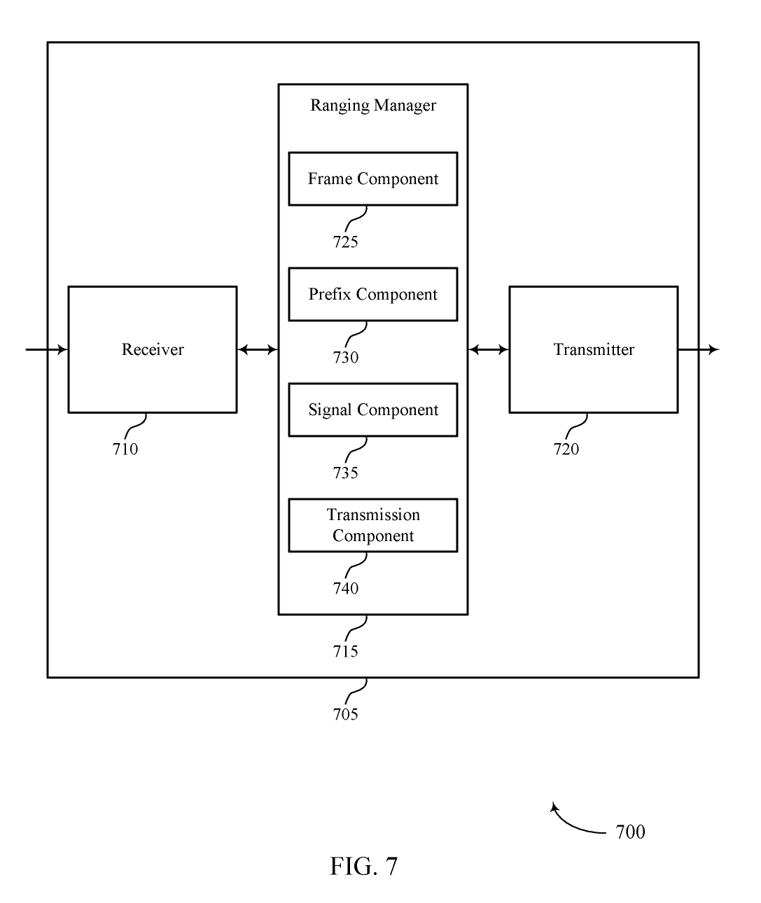

FIG. 7 shows a block diagram 700 of a wireless device 705 that supports protection of ranging sounding from prefix replay attacks in accordance with aspects of the present disclosure. Wireless device 705 may be an example of aspects of a wireless device 605 as described with reference to FIG. 6 or an initiator as described herein. Wireless device 705 may include receiver 710, ranging manager 715, and transmitter 720. Wireless device 705 may also include a processor. Each of these components may be in communication with one another (such as via one or more buses).

Receiver 710 may receive information such as packets, user data, or control information associated with various information channels (such as control channels, data channels, and information related to protection of ranging sounding from prefix replay attacks, etc.). Information may be passed on to other components of the device. The receiver 710 may be an example of aspects of the transceiver 935 described with reference to FIG. 9. The receiver 710 may utilize a single antenna or a set of antennas. Ranging manager 715 may be an example of aspects of the ranging manager 915 described with reference to FIG. 9. Ranging manager 715 may also include frame component 725, prefix component 730, signal component 735, and transmission component 740.

Frame component 725 may identify a ranging measurement signal including a cyclic prefix for transmission to a wireless device. In some cases, the ranging measurement signal includes an OFDM signal. In some cases, the ranging measurement signal includes an FTM signal, an NDP, or an ACK signal. In some example, a symbol prefix may be an example of a cyclic prefix.

Prefix component 730 may determine a modified symbol prefix for the ranging measurement frame based on a repeated portion of the symbol prefix and update the symbol prefix with a set of null data values, where the generated signal is based on updating the symbol prefix with the set of null data values. In some cases, determining the modified symbol prefix includes: determining a set of zero-value samples, where the modified symbol prefix includes a set of zero-value-modulated sample symbols corresponding to the set of zero-value samples. In some examples, determining the modified symbol prefix includes: determining a pseudo random sequence to modulate the symbol prefix, where the modified symbol prefix includes a sequence of symbols modulated with the pseudo random sequence. In some instances, the modified symbol prefix includes a gap interval that includes a sequence of zero modulated sample symbols. In some aspects, determining the modified symbol prefix includes: determining a modified set of modulated sample symbols that is different than a set of modulated sample symbols of the symbol prefix and used to replace a repetition of the part of the symbol corresponding to the symbol prefix at an end of the ranging measurement frame. In some cases, the symbol prefix includes one of a short cyclic prefix or a long cyclic prefix.

Signal component 735 may generate a modified ranging measurement signal comprising a modified cyclic prefix for transmission in a ranging measurement frame, where the modified cyclic prefix is not a repeated portion of the modified ranging measurement signal. In some cases, the signal component 735 may update the cyclic prefix with a set of null data values, where the modified cyclic prefix is based on updating the cyclic prefix with the set of null data values. In some cases, generating the modified ranging measurement signal includes: determining a set of zero-value samples, where the modified cyclic prefix includes a set of zero-value-modulated sample symbols corresponding to the set of zero-value samples.

In some examples, generating the modified ranging measurement signal includes: determining a pseudo random sequence to modulate the cyclic prefix, where the modified cyclic prefix includes a sequence of symbols modulated with the pseudo random sequence. In some instances, the modified cyclic prefix includes a gap interval that includes a sequence of zero modulated sample symbols. In some aspects, generating the modified ranging measurement signal includes: determining a modified set of modulated symbols for the modified cyclic prefix that is different than a set of modulated sample symbols of the cyclic prefix. In some cases, the modified set of modulated symbols are used to replace a repetition of the cyclic prefix. In some cases, the cyclic prefix includes one of a short cyclic prefix or a long cyclic prefix. In some cases, a modified symbol prefix may be generated as described herein.

In some cases, the cyclic prefix comprises a repeated portion of the ranging measurement signal, and where the modified cyclic prefix includes a zeroed-out cyclic prefix, a set of zero-value-modulated symbols, no transmission, or an unmodulated carrier. Transmission component 740 may transmit the modified ranging measurement signal in the ranging measurement frame.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas.

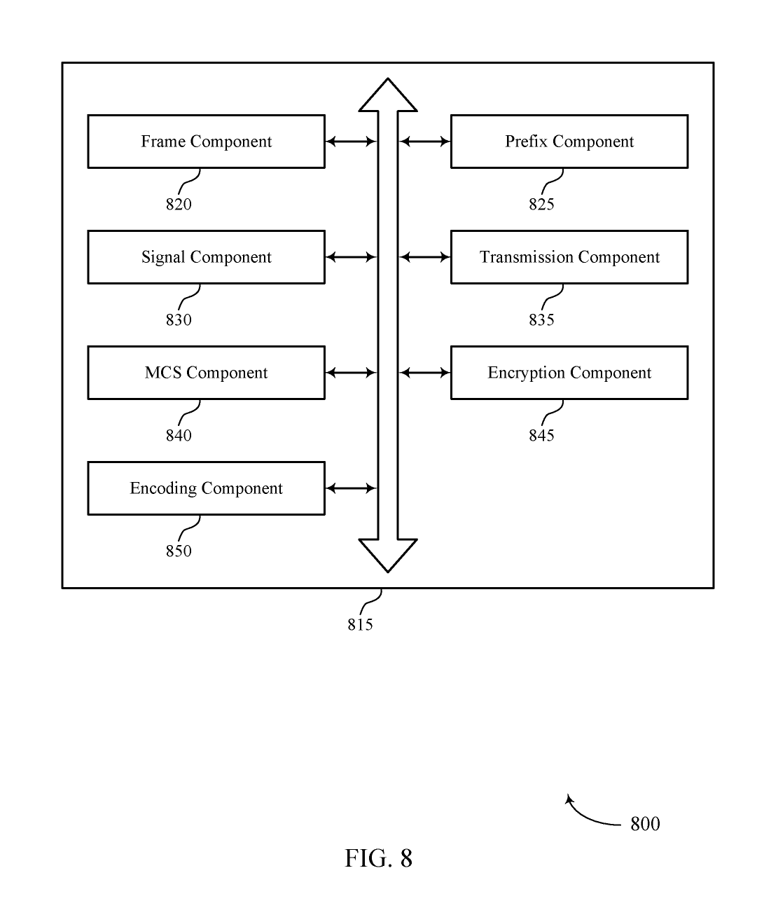

FIG. 8 shows a block diagram 800 of a ranging manager 815 that supports protection of ranging sounding from prefix replay attacks in accordance with aspects of the present disclosure. The ranging manager 815 may be an example of aspects of a ranging manager 615, a ranging manager 715, or a ranging manager 915 described with reference to FIGS. 6, 7, and 9. The ranging manager 815 may include frame component 820, prefix component 825, signal component 830, transmission component 835, MCS component 840, encryption component 845, and encoding component 850. Each of these modules may communicate, directly or indirectly, with one another (such as via one or more buses).

Frame component 820 may identify a ranging measurement signal including a cyclic prefix for transmission to a wireless device. In some cases, the ranging measurement signal includes an OFDM signal. In some cases, the ranging measurement signal includes an FTM signal, an NDP, or an ACK signal. In some cases, a symbol prefix may be an example of a cyclic prefix.

Prefix component 825 may determine a modified symbol prefix for the ranging measurement frame based on a repeated portion of the symbol prefix. In some cases, the prefix component 825 may update the symbol prefix with a set of null data values, where the generated signal is based on updating the symbol prefix with the set of null data values. In some cases, determining the modified symbol prefix includes: determining a set of zero-value samples, where the modified symbol prefix includes the set of zero-value-modulated sample symbols corresponding to the set of zero-value samples. In some examples, determining the modified symbol prefix includes: determining a pseudo random sequence to modulate the symbol prefix, where the modified symbol prefix includes a sequence of symbols modulated with the pseudo random sequence. In some aspects, the modified symbol prefix includes a gap interval that includes a sequence of zero modulated sample symbols. In some instances, determining the modified symbol prefix includes: determining a modified set of modulated sample symbols that is different than a set of modulated sample symbols of the symbol prefix and used to replace a repetition of the part of the symbol at the end of the symbol corresponding to the symbol prefix. In some cases, the symbol prefix includes one of a short cyclic prefix or a long cyclic prefix.

Signal component 830 may generate a modified ranging measurement signal comprising a modified cyclic prefix for transmission in a ranging measurement frame, where the modified cyclic prefix is not a repeated portion of the modified ranging measurement signal. In some cases, the signal component 830 may update the cyclic prefix with a set of null data values, where the modified cyclic prefix is based on updating the cyclic prefix with the set of null data values. In some cases, generating the modified ranging measurement signal includes: determining a set of zero-value samples, where the modified cyclic prefix includes a set of zero-value-modulated sample symbols corresponding to the set of zero-value samples. In some examples, generating the modified ranging measurement signal includes: determining a pseudo random sequence to modulate the cyclic prefix, where the modified cyclic prefix includes a sequence of symbols modulated with the pseudo random sequence.

In some instances, the modified cyclic prefix includes a gap interval that includes a sequence of zero modulated sample symbols. In some aspects, generating the modified ranging measurement signal includes: determining a modified set of modulated symbols for the modified cyclic prefix that is different than a set of modulated symbols of the cyclic prefix. In some cases, the modified set of modulated symbols are used to replace a repetition of the cyclic prefix. In some cases, the cyclic prefix includes one of a short cyclic prefix or a long cyclic prefix. In some cases, a modified symbol prefix may be generated as described herein.

In some cases, the cyclic prefix comprises a repeated portion of the ranging measurement signal, and where the modified cyclic prefix includes a gap interval, a zeroed-out cyclic prefix, a set of zero-value-modulated symbols, no transmission, or an unmodulated carrier. Transmission component 835 may transmit the modified ranging measurement signal in the ranging measurement frame.

MCS component 840 may identify a restricted MCS for the ranging measurement frame, where the ranging measurement frame is transmitted according to the restricted MCS. In some cases, identifying the restricted MCS includes: negotiating a value for the restricted MCS based on a ranging operation.

Encryption component 845 may encrypt a channel estimation training sequence of the ranging measurement frame, where the transmitted ranging measurement frame includes the encrypted channel estimation training sequence and perform a medium reservation operation based on transmission of the encrypted channel estimation training sequence, where the medium reservation operation includes a MAC layer signaling technique. Encryption component 845 may transmit an RTS message including NAV timing information and receive, in response to the RTS message, a CTS message, where transmitting the ranging measurement frame is based on the CTS message. Encryption component 845 may transmit, before transmission of the ranging measurement frame, an encryption key corresponding to the encrypted channel estimation training sequence and receive, from the wireless device, a second ranging measurement frame that includes encryption information for a ranging measurement ACK frame. In some cases, the second ranging measurement frame may be received before the first ranging measurement frame. Encryption component 845 may encrypt a channel estimation field of the ranging measurement ACK frame based on the encryption information and transmit the ranging measurement ACK frame in response to the first ranging measurement frame. In some cases, the encrypted channel estimation training sequence includes a long training field.

Encoding component 850 may encode a channel estimation field of the ranging measurement frame, where the transmitted ranging measurement frame includes the encoded channel estimation field and establish a ranging negotiation session with the wireless device. Encoding component 850 may determine, during the ranging negotiation session, an encryption key for the ranging measurement frame, where the channel estimation field is encoded based on the encryption key and transmit, during the ranging negotiation, an indication of the encryption key to the wireless device. Encoding component 850 may convey channel estimation field encoding information in a field subsequent to the channel estimation field of the ranging measurement frame and convey channel estimation field encoding information in a frame subsequent to transmission of the ranging measurement frame. In some cases, the encryption key is determined based on a master key and a previously received measurement or measurement feedback frame (such as previously received ACK or any other previously received frame with variable content). In some examples, the channel estimation field encoding information is included in at least one of an HT PE, VHT PE, an HE PE, or any combination thereof.

FIG. 9 shows a diagram of a system 900 including a device 905 that supports protection of ranging sounding from prefix replay attacks in accordance with aspects of the present disclosure. Device 905 may be an example of or include the components of wireless device 605, wireless device 705, or an initiator as described above, such as with reference to FIGS. 6 and 7. Device 905 may include components for bi-directional voice and data communications including components for transmitting and receiving communications, including ranging manager 915, processor 920, memory 925, software 930, transceiver 935, antenna 940, and I/O controller 945. These components may be in electronic communication via one or more buses (such as bus 910). Device 905 may communicate wirelessly with one or more base stations 105.

Processor 920 may include an intelligent hardware device, (such as a general-purpose processor, a DSP, a central processing unit (CPU), a microcontroller, an ASIC, an FPGA, a PLD, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (such as functions or tasks supporting protection of ranging sounding from prefix replay attacks).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support protection of ranging sounding from prefix replay attacks. Software 930 may be stored in a non-transitory computer-readable medium such as system memory or other memory. In some cases, the software 930 may not be directly executable by the processor but may cause a computer (such as when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

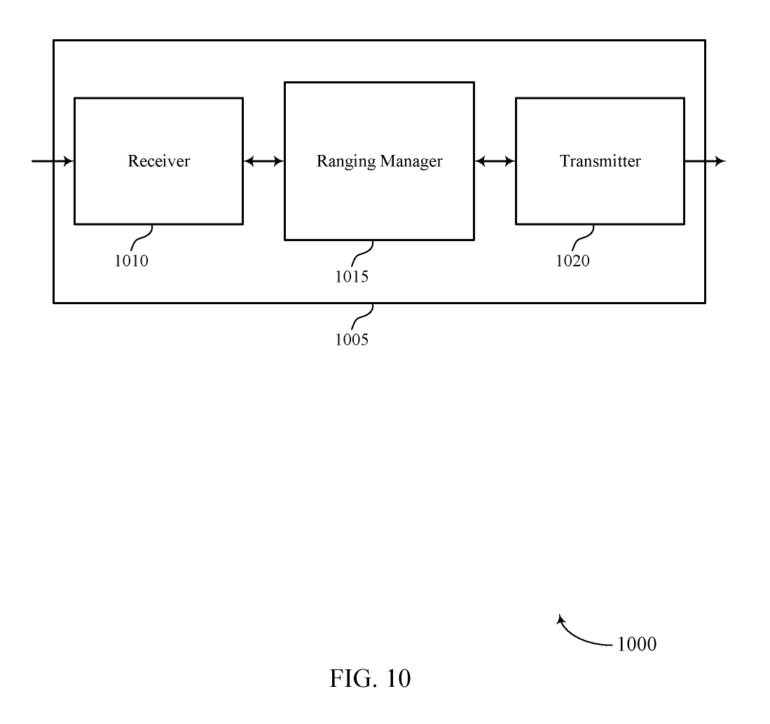

FIG. 10 shows a block diagram 1000 of a wireless device 1005 that supports protection of ranging sounding from prefix replay attacks in accordance with aspects of the present disclosure. Wireless device 1005 may be an example of aspects of a responder as described herein. Wireless device 1005 may include receiver 1010, ranging manager 1015, and transmitter 1020. Wireless device 1005 may also include a processor. Each of these components may be in communication with one another (such as via one or more buses).

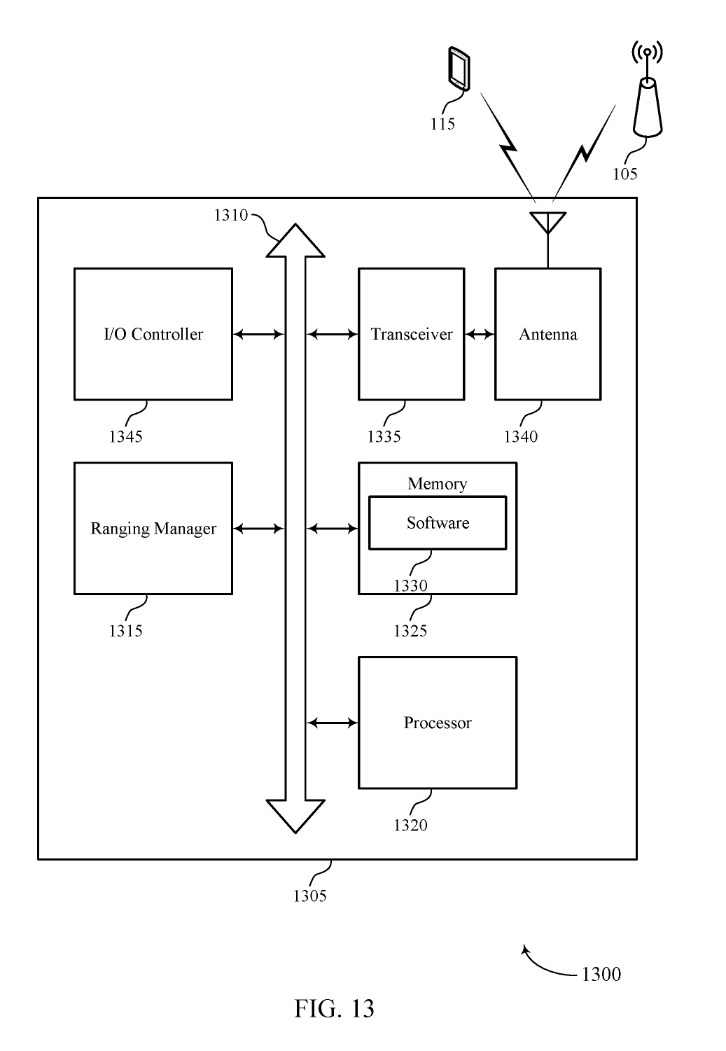

Receiver 1010 may receive information such as packets, user data, or control information associated with various information channels (such as control channels, data channels, and information related to protection of ranging sounding from prefix replay attacks, etc.). Information may be passed on to other components of the device. The receiver 1010 may be an example of aspects of the transceiver 1335 described with reference to FIG. 13. The receiver 1010 may utilize a single antenna or a set of antennas.

Ranging manager 1015 may be an example of aspects of the ranging manager 1315 described with reference to FIG. 13.

Ranging manager 1015 and/or at least some of its various sub-components may be implemented in hardware, software executed by a processor, firmware, or any combination thereof. If implemented in software executed by a processor, the functions of the ranging manager 1015 and/or at least some of its various sub-components may be executed by a general-purpose processor, a DSP, an ASIC, an FPGA or other PLD, discrete gate or transistor logic, discrete hardware components, or any combination thereof designed to perform the functions described in the present disclosure.

The ranging manager 1015 and/or at least some of its various sub-components may be physically located at different locations, including being distributed such that portions of functions are implemented at different physical locations by one or more physical devices. In some examples, ranging manager 1015 and/or at least some of its various sub-components may be a separate and distinct component in accordance with various aspects of the present disclosure. In other examples, ranging manager 1015 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Ranging manager 1015 may receive, from a wireless device, a ranging measurement signal in a ranging measurement frame including a cyclic prefix, where the cyclic prefix is a zeroed-out cyclic prefix or a sequence of symbols modulated with a pseudo random sequence. In some cases, ranging manager 1015 may receive, a ranging measurement signal in a ranging measurement frame including a cyclic prefix, where the cyclic prefix is a zeroed-out cyclic prefix or a sequence of symbols modulated with a pseudo random sequence. In some cases, the ranging measurement frame includes a cyclic prefix that includes a set of modulated sample symbols, the set of modulated sample symbols consisting of a set of zero-value-modulated sample symbols or a sequence of symbols modulated with a pseudo random sequence. Ranging manager 1015 may determine a channel estimation technique that accounts for the zeroed-out cyclic prefix or the sequence of sample symbols modulated with the pseudo random sequence and estimate a channel from the ranging measurement frame based on the channel estimation technique. In some cases, the zeroed-out cyclic prefix includes a set of zero-value-modulated sample symbols, no transmission, or an unmodulated carrier, or any combination thereof. In some cases, a symbol prefix may be an example of a cyclic prefix.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1335 described with reference to FIG. 13. The transmitter 1020 may utilize a single antenna or a set of antennas.

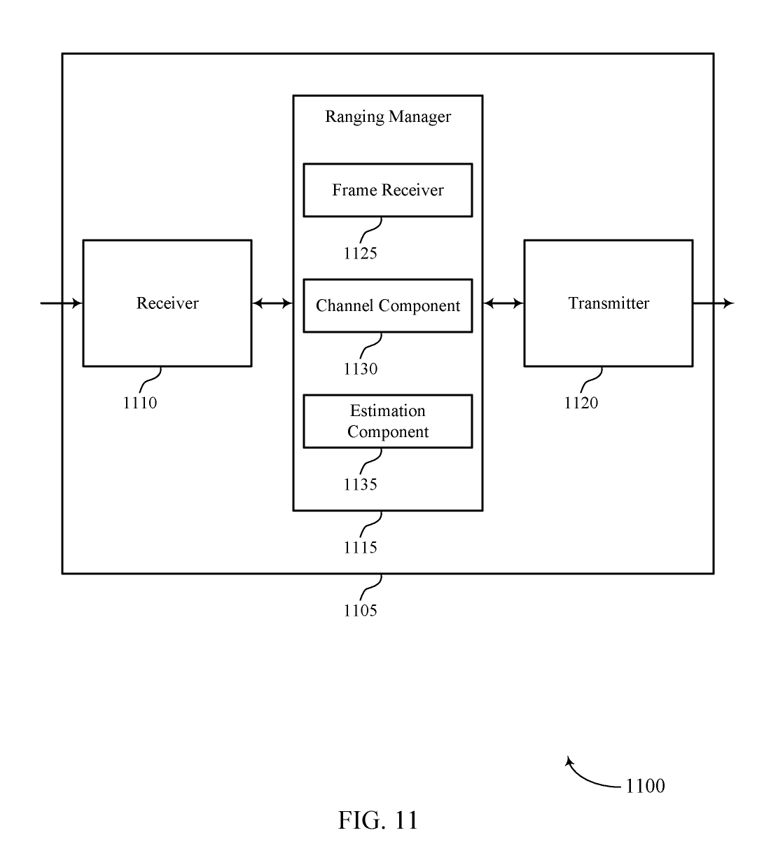

FIG. 11 shows a block diagram 1100 of a wireless device 1105 that supports protection of ranging sounding from prefix replay attacks in accordance with aspects of the present disclosure. Wireless device 1105 may be an example of aspects of a wireless device 1005 or a responder as described with reference to FIG. 10. Wireless device 1105 may include receiver 1110, ranging manager 1115, and transmitter 1120. Wireless device 1105 may also include a processor. Each of these components may be in communication with one another (such as via one or more buses).

Receiver 1110 may receive information such as packets, user data, or control information associated with various information channels (such as control channels, data channels, and information related to protection of ranging sounding from prefix replay attacks, etc.). Information may be passed on to other components of the device. The receiver 1110 may be an example of aspects of the transceiver 1335 described with reference to FIG. 13. The receiver 1110 may utilize a single antenna or a set of antennas.

Ranging manager 1115 may be an example of aspects of the ranging manager 1315 described with reference to FIG. 13. Ranging manager 1115 may also include frame receiver 1125, channel component 1130, and estimation component 1135.

Frame receiver 1125 may receive, from a wireless device, a ranging measurement frame including a cyclic prefix that includes a set of modulated sample symbols, the set of modulated sample symbols consisting of a set of zero-value-modulated sample symbols or a sequence of symbols modulated with a pseudo random sequence. In some cases, the cyclic prefix includes one of a short cyclic prefix or a long cyclic prefix. In some examples, the ranging measurement frame includes an FTM signal, an NDP, or an ACK signal.

Channel component 1130 may determine a channel estimation technique that accounts for the zeroed-out cyclic prefix or the sequence of sample symbols modulated with the pseudo random sequence.

Estimation component 1135 may estimate a channel from the ranging measurement frame based on the channel estimation technique. In some cases, estimating the channel includes: modeling the channel as an FIR filter and determining a system of equations based on the FIR filter. In some examples, estimating the channel further includes: performing a least squares operation using the system of equations.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may utilize a single antenna or a set of antennas.

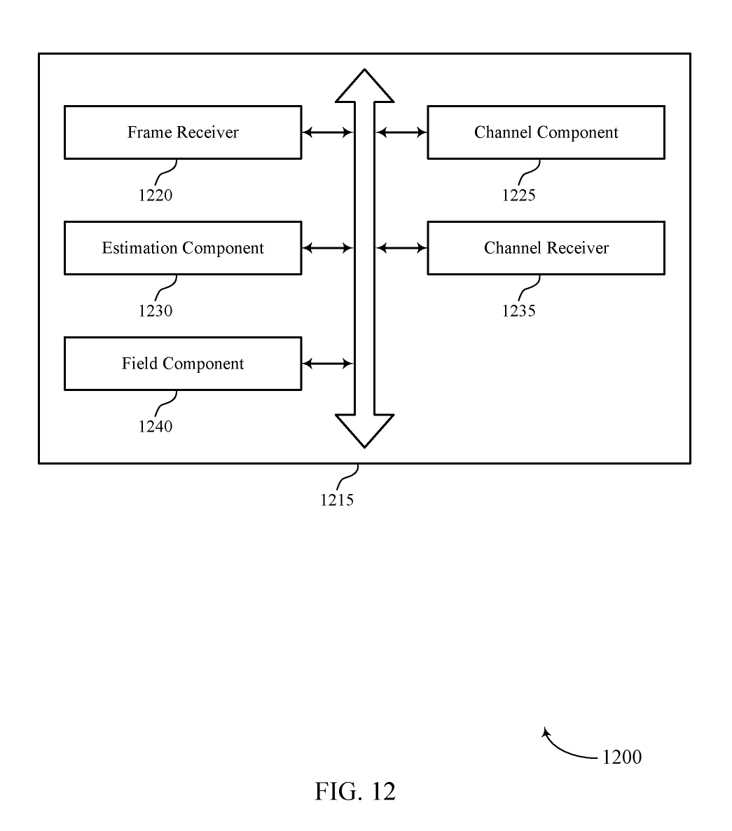

FIG. 12 shows a block diagram 1200 of a ranging manager 1215 that supports protection of ranging sounding from prefix replay attacks in accordance with aspects of the present disclosure. The ranging manager 1215 may be an example of aspects of a ranging manager 1315 described with reference to FIGS. 10, 11, and 13. The ranging manager 1215 may include frame receiver 1220, channel component 1225, estimation component 1230, channel receiver 1235, and field component 1240. Each of these modules may communicate, directly or indirectly, with one another (such as via one or more buses).

Frame receiver 1220 may receive, from a wireless device, a ranging measurement signal in a ranging measurement frame including a cyclic prefix, where the cyclic prefix is a zeroed-out cyclic prefix or a sequence of symbols modulated with a pseudo random sequence. In some cases, the ranging measurement frame includes a symbol prefix that includes a set of modulated sample symbols, the set of modulated sample symbols consisting of a set of zero-value-modulated sample symbols. In some cases, the cyclic prefix includes one of a short cyclic prefix or a long cyclic prefix. In some examples, the ranging measurement frame includes an FTM signal, an NDP, or an ACK signal. In some cases, the zeroed-out cyclic prefix includes a set of zero-value-modulated sample symbols, no transmission, or an unmodulated carrier, or any combination thereof.

Channel component 1225 may determine a channel estimation technique that accounts for the zeroed-out cyclic prefix or the sequence of sample symbols modulated with the pseudo random sequence.

Estimation component 1230 may estimate a channel from the ranging measurement frame based on the channel estimation technique. In some cases, estimating the channel includes: modeling the channel as an FIR filter and determining a system of equations based on the FIR filter. In some examples, estimating the channel further includes: performing a least squares operation using the system of equations.

Channel receiver 1235 may receive a channel estimation training sequence from the ranging measurement frame, where the channel estimation training sequence is encrypted using an encryption key and establish a ranging negotiation session with the wireless device. Channel receiver 1235 may determine, during the ranging negotiation session, the encryption key for the ranging measurement frame and decrypt the channel estimation training sequence based on the encryption key.

Field component 1240 may identify an encoded channel estimation field of the ranging measurement frame and receive channel estimation encoding information in a field subsequent to the channel estimation field. Field component 1240 may decode the channel estimation field based on the channel estimation encoding information. In some cases, the channel estimation field encoding information is included in at least one of an HT PE, VHT PE, an HE PE, or any combination thereof.

FIG. 13 shows a diagram of a system 1300 including a device 1305 that supports protection of ranging sounding from prefix replay attacks in accordance with aspects of the present disclosure. Device 1305 may be an example of or include the components of a responder as described above. Device 1305 may include components for bi-directional voice and data communications including components for transmitting and receiving communications, including ranging manager 1315, processor 1320, memory 1325, software 1330, transceiver 1335, antenna 1340, network communications manager 1345, and inter-station communications manager 1350. These components may be in electronic communication via one or more buses (such as bus 1310). Device 1305 may communicate wirelessly with one or more STAs 115 or APs 105.

Processor 1320 may include an intelligent hardware device, (such as a general-purpose processor, a DSP, a CPU, a microcontroller, an ASIC, an FPGA, a PLD, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (such as functions or tasks supporting protection of ranging sounding from prefix replay attacks).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware or software operation such as the interaction with peripheral components or devices.

Software 1330 may include code to implement aspects of the present disclosure, including code to support protection of ranging sounding from prefix replay attacks. Software 1330 may be stored in a non-transitory computer-readable medium such as system memory or other memory. In some cases, the software 1330 may not be directly executable by the processor but may cause a computer (such as when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

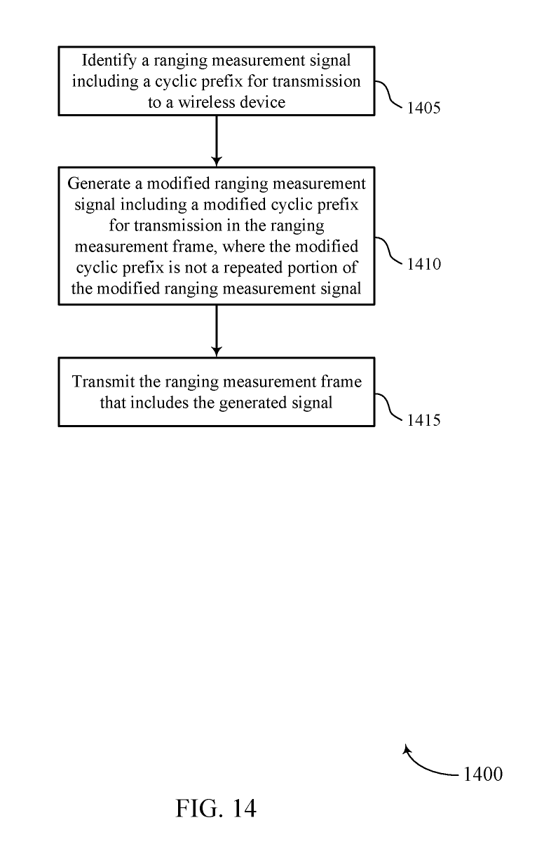

FIG. 14 shows a flowchart illustrating a method 1400 for protection of ranging sounding from prefix replay attacks in accordance with aspects of the present disclosure. The operations of method 1400 may be implemented by an initiator or its components as described herein. For example, the operations of method 1400 may be performed by a ranging manager as described with reference to FIGS. 6 through 9. In some examples, an initiator may execute a set of codes to control the functional elements of the device to perform the functions described below. Additionally or alternatively, the UE 115 may perform aspects of the functions described below using special-purpose hardware.

At block 1405 the initiator may identify a ranging measurement signal including a cyclic prefix for transmission to a wireless device. The operations of block 1405 may be performed according to the methods described herein. In certain examples, aspects of the operations of block 1405 may be performed by a frame component as described with reference to FIGS. 6 through 9.

At block 1410 the initiator may generate a modified ranging measurement signal including a modified cyclic prefix for transmission in the ranging measurement frame, where the modified cyclic prefix is not a repeated portion of the modified ranging measurement signal. The operations of block 1410 may be performed according to the methods described herein. In certain examples, aspects of the operations of block 1410 may be performed by a signal component as described with reference to FIGS. 6 through 9.

At block 1415 the initiator may transmit the ranging measurement frame that includes the generated signal. The operations of block 1415 may be performed according to the methods described herein. In certain examples, aspects of the operations of block 1415 may be performed by a transmission component as described with reference to FIGS. 6 through 9.

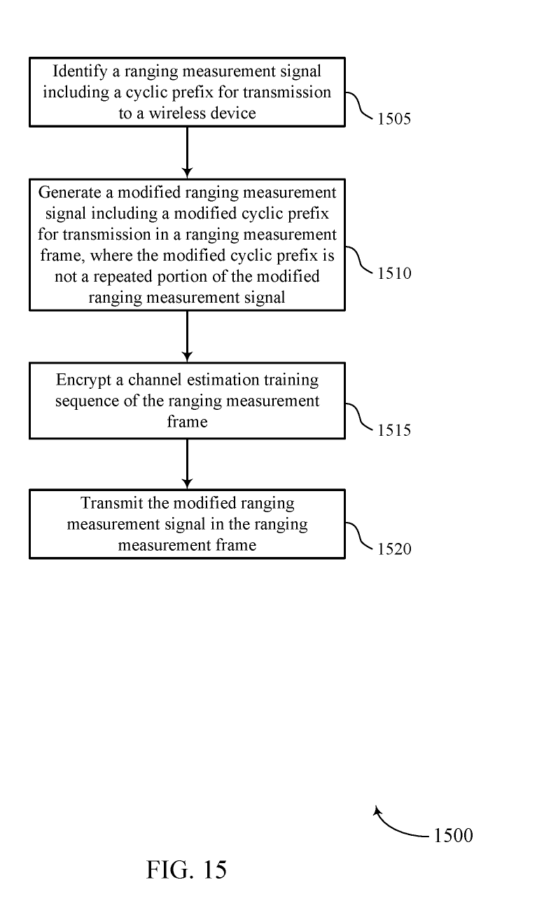

FIG. 15 shows a flowchart illustrating a method 1500 for protection of ranging sounding from prefix replay attacks in accordance with aspects of the present disclosure. The operations of method 1500 may be implemented by an initiator or its components as described herein. For example, the operations of method 1500 may be performed by a ranging manager as described with reference to FIGS. 6 through 9. In some examples, an initiator may execute a set of codes to control the functional elements of the device to perform the functions described below. Additionally or alternatively, the initiator may perform aspects of the functions described below using special-purpose hardware.

At block 1505 the initiator may identify a ranging measurement frame comprising a cyclic prefix for transmission to a wireless device. The operations of block 1505 may be performed according to the methods described herein. In certain examples, aspects of the operations of block 1505 may be performed by a frame component as described with reference to FIGS. 6 through 9.

At block 1510 the initiator may generate a modified ranging measurement signal including a modified cyclic prefix for transmission in a ranging measurement frame, where the modified cyclic prefix is not a repeated portion of the modified ranging measurement signal. The operations of block 1510 may be performed according to the methods described herein. In certain examples, aspects of the operations of block 1510 may be performed by a signal component as described with reference to FIGS. 6 through 9.

At block 1515 the initiator may encrypt a channel estimation training sequence of the ranging measurement frame. The operations of block 1515 may be performed according to the methods described herein. In certain examples, aspects of the operations of block 1515 may be performed by an encryption component as described with reference to FIGS. 6 through 9.

At block 1520 the initiator may transmit the ranging measurement frame that includes the generated signal. The operations of block 1520 may be performed according to the methods described herein. In certain examples, aspects of the operations of block 1520 may be performed by a transmission component as described with reference to FIGS. 6 through 9.

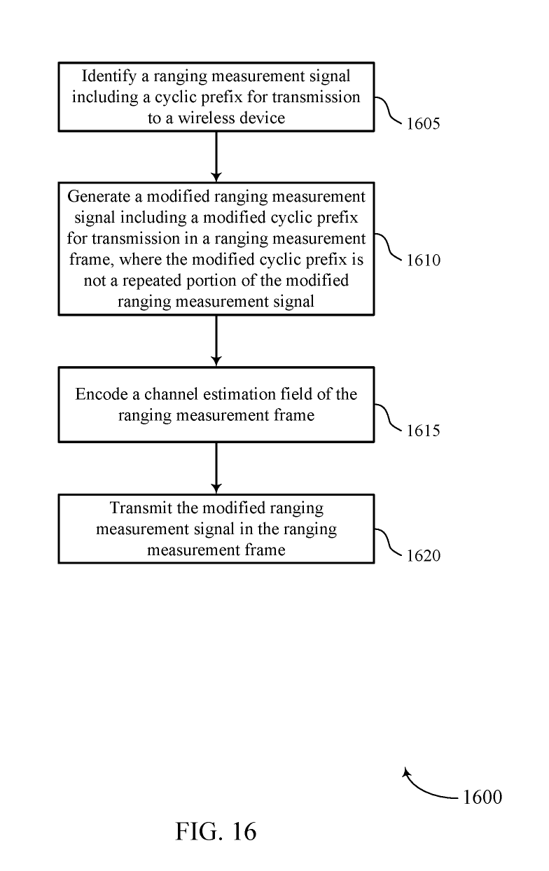

FIG. 16 shows a flowchart illustrating a method 1600 for protection of ranging sounding from prefix replay attacks in accordance with aspects of the present disclosure. The operations of method 1600 may be implemented by an initiator or its components as described herein. For example, the operations of method 1600 may be performed by a ranging manager as described with reference to FIGS. 6 through 9. In some examples, an initiator may execute a set of codes to control the functional elements of the device to perform the functions described below. Additionally or alternatively, the initiator may perform aspects of the functions described below using special-purpose hardware.

At block 1605 the initiator may identify a ranging measurement signal including a cyclic prefix for transmission to a wireless device. The operations of block 1605 may be performed according to the methods described herein. In certain examples, aspects of the operations of block 1605 may be performed by a frame component as described with reference to FIGS. 6 through 9.

At block 1610 the initiator may generate a modified ranging measurement signal including a modified cyclic prefix for transmission in a ranging measurement frame, where the modified cyclic prefix is not a repeated portion of the modified ranging measurement signal. The operations of block 1610 may be performed according to the methods described herein. In certain examples, aspects of the operations of block 1610 may be performed by a signal component as described with reference to FIGS. 6 through 9.

At block 1615 the initiator may encode a channel estimation field of the ranging measurement frame. The operations of block 1615 may be performed according to the methods described herein. In certain examples, aspects of the operations of block 1615 maybe performed by a encoding component as described with reference to FIGS. 6 through 9.

At block 1620 the initiator may transmit the modified ranging measurement signal in the ranging measurement frame. The operations of block 1620 may be performed according to the methods described herein. In certain examples, aspects of the operations of block 1620 may be performed by a transmission component as described with reference to FIGS. 6 through 9.

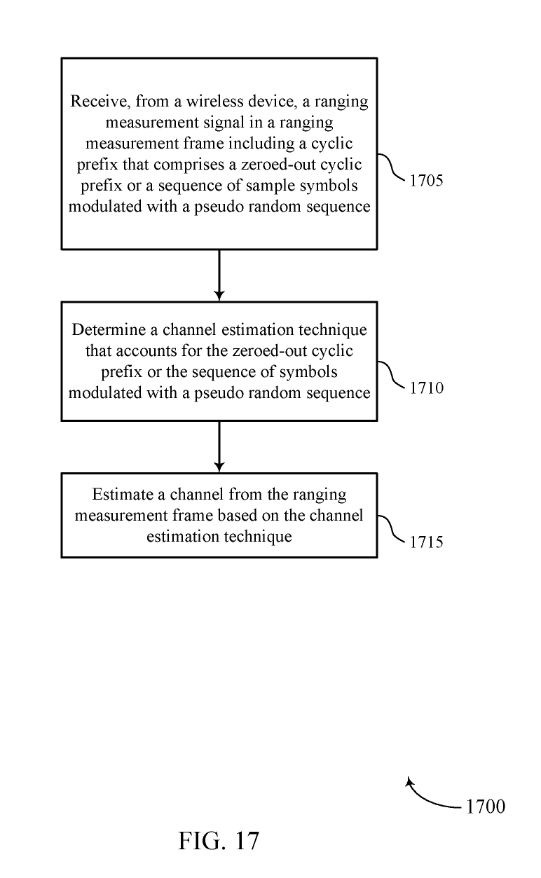

FIG. 17 shows a flowchart illustrating a method 1700 for protection of ranging sounding from prefix replay attacks in accordance with aspects of the present disclosure. The operations of method 1700 may be implemented by a responder or its components as described herein. For example, the operations of method 1700 may be performed by a ranging manager as described with reference to FIGS. 10 through 13. In some examples, a responder may execute a set of codes to control the functional elements of the device to perform the functions described below. Additionally or alternatively, the responder may perform aspects of the functions described below using special-purpose hardware.

At block 1705 the responder may receive, from a wireless device, a ranging measurement signal in a ranging measurement frame including a cyclic prefix that comprises a zeroed-out cyclic prefix or a sequence of symbols modulated with a pseudo random sequence. The operations of block 1705 may be performed according to the methods described herein. In certain examples, aspects of the operations of block 1705 may be performed by a frame receiver as described with reference to FIGS. 10 through 13.

At block 1710 the responder may determine a channel estimation technique that accounts for the zeroed-out cyclic prefix or the sequence of sample symbols modulated with the pseudo random sequence. The operations of block 1710 may be performed according to the methods described herein. In certain examples, aspects of the operations of block 1710 may be performed by a channel component as described with reference to FIGS. 10 through 13.

At block 1715 the responder may estimate a channel from the ranging measurement frame based on the channel estimation technique. The operations of block 1715 may be performed according to the methods described herein. In certain examples, aspects of the operations of block 1715 may be performed by a estimation component as described with reference to FIGS. 10 through 13.

It should be noted that the methods described above describe possible implementations, and that the operations and the steps may be rearranged or otherwise modified and that other implementations are possible. Further, aspects from two or more of the methods may be combined.

In some examples, aspects from two or more of the methods 1400, 1500, 1600, or 1700 described with reference to FIG. 14, 15, 16, or 17 may be combined. It should be noted that the methods 1400, 1500, 1600, and 1700 are just example implementations, and that the operations of the methods 1400, 1500, 1600, or 1700 may be rearranged or otherwise modified such that other implementations are possible

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (such as several kilometers in radius) and may allow unrestricted access by UEs 115 with service subscriptions with the network provider. A small cell may be associated with a lower-powered base station 105, as compared with a macro cell, and a small cell may operate in the same or different (such as licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (such as a home) and may provide restricted access by UEs 115 having an association with the femto cell (such sa UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (such as two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other PLD, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at different locations, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying a ranging measurement signal comprising a cyclic prefix for transmission to a wireless device;
generating a modified ranging measurement signal comprising a modified cyclic prefix for transmission in a ranging measurement frame, wherein the modified cyclic prefix is not a repeated portion of the modified ranging measurement signal; and
transmitting the modified ranging measurement signal in the ranging measurement frame.

2. The method of claim 1, wherein the cyclic prefix comprises a repeated portion of the ranging measurement signal, and wherein the modified cyclic prefix comprises a gap interval, a zeroed-out cyclic prefix, a set of zero-value-modulated symbols, no transmission, or an unmodulated carrier.

3. The method of claim 1, wherein generating the modified ranging measurement signal comprises determining a pseudo random sequence to modulate the cyclic prefix, wherein the modified cyclic prefix consists of a sequence of symbols modulated with the pseudo random sequence.

4. The method of claim 1, further comprising identifying a restricted modulation and coding scheme (MCS) for the ranging measurement frame, wherein the ranging measurement frame is transmitted according to the restricted MCS.

5. The method of claim 4, wherein identifying the restricted MCS comprises negotiating a value for the restricted MCS based at least in part on a ranging operation.

6. The method of claim 1, wherein generating the modified ranging measurement signal comprises determining a modified set of modulated symbols for the modified cyclic prefix that is different than a set of modulated symbols of the cyclic prefix.

7. The method of claim 1, further comprising encrypting a channel estimation training sequence of the ranging measurement frame, wherein the transmitted ranging measurement frame includes the encrypted channel estimation training sequence.

8. The method of claim 7, further comprising performing a medium reservation operation based at least in part on transmission of the encrypted channel estimation training sequence, wherein the medium reservation operation comprises a medium access control (MAC) layer signaling technique.

9. The method of claim 7, further comprising:
transmitting a request-to-send (RTS) message comprising network allocation vector (NAV) timing information; and
receiving, in response to the RTS message, a clear-to-send (CTS) message, wherein transmitting the ranging measurement frame is based at least in part on the CTS message.

10. The method of claim 7, further comprising transmitting, before transmission of the ranging measurement frame, an encryption key corresponding to the encrypted channel estimation training sequence.

11. The method of claim 7, further comprising:
receiving, from the wireless device, a second ranging measurement frame that comprises encryption information for a ranging measurement acknowledgement (ACK) frame; and
encrypting a channel estimation field of the ranging measurement ACK frame based at least in part on the encryption information.

12. The method of claim 1, further comprising encoding a channel estimation field of the ranging measurement frame, wherein the transmitted ranging measurement frame includes the encoded channel estimation field.

13. The method of claim 12, further comprising:
establishing a ranging negotiation session with the wireless device; and
determining, during the ranging negotiation session, an encryption key for the ranging measurement frame, wherein the channel estimation field is encoded based at least in part on the encryption key.

14. The method of claim 13, further comprising transmitting, during the ranging negotiation, an indication of the encryption key to the wireless device.

15. The method of claim 13, wherein the encryption key is determined based at least in part on a master key and a previously received measurement or measurement feedback frame.

16. The method of claim 12, further comprising conveying channel estimation field encoding information in a field subsequent to the channel estimation field of the ranging measurement frame.

17. The method of claim 12, further comprising conveying channel estimation field encoding information in a frame subsequent to transmission of the ranging measurement frame.

18. A method for wireless communication, comprising:
receiving, from a wireless device, a ranging measurement signal in a ranging measurement frame including a cyclic prefix, wherein the cyclic prefix is a zeroed-out cyclic prefix or a sequence of symbols modulated with a pseudo random sequence;
determining a channel estimation technique that accounts for the zeroed-out cyclic prefix or the sequence of sample symbols modulated with the pseudo random sequence; and
estimating a channel from the ranging measurement frame based at least in part on the channel estimation technique.

19. The method of claim 18, wherein the zeroed-out cyclic prefix comprises a set of zero-value-modulated sample symbols, no transmission, or an unmodulated carrier, or any combination thereof.

20. The method of claim 18, wherein estimating the channel comprises modeling the channel as a finite impulse response (FIR) filter and determining a system of equations based at least in part on the FIR filter.

21. The method of claim 20, wherein estimating the channel further comprises performing a least squares operation using the system of equations.

22. The method of claim 18, further comprising receiving a channel estimation training sequence from the ranging measurement frame, wherein the channel estimation training sequence is encrypted using an encryption key.

23. The method of claim 22, further comprising:
establishing a ranging negotiation session with the wireless device;
determining, during the ranging negotiation session, the encryption key for the ranging measurement frame; and
decrypting the channel estimation training sequence based at least in part on the encryption key.

24. The method of claim 18, further comprising:
identifying an encoded channel estimation field of the ranging measurement frame;
receiving channel estimation encoding information in a field subsequent to the channel estimation field; and
decoding the channel estimation field based at least in part on the channel estimation encoding information.

25. An apparatus for wireless communication, comprising:
a processor;
memory in electronic communication with the processor; and
instructions stored in the memory and executable by the processor to cause the apparatus to:
identify a ranging measurement signal comprising a cyclic prefix for transmission to a wireless device;
generate a modified ranging measurement signal comprising a modified cyclic prefix for transmission in a ranging measurement frame, wherein the modified cyclic prefix is not a repeated portion of the modified ranging measurement signal; and
transmit the ranging measurement signal in the ranging measurement frame.

26. The apparatus of claim 25, wherein the cyclic prefix comprises a repeated portion of the ranging measurement signal, and wherein the modified cyclic prefix comprises a gap interval, a zeroed-out cyclic prefix, a set of zero-value-modulated symbols, no transmission, or an unmodulated carrier.

27. The apparatus of claim 25, further comprising instructions stored in the memory and executable by the processor to cause the apparatus to:
determine a pseudo random sequence to modulate the cyclic prefix, wherein the modified cyclic prefix consists of a sequence of symbols modulated with the pseudo random sequence.

28. An apparatus for wireless communication, comprising:
a processor;
memory in electronic communication with the processor; and
instructions stored in the memory and executable by the processor to cause the apparatus to:
receive, from a wireless device, a ranging measurement signal in a ranging measurement frame including a cyclic prefix, wherein the cyclic prefix is a zeroed-out cyclic prefix or a sequence of symbols modulated with a pseudo random sequence;
determine a channel estimation technique that accounts for the zeroed-out cyclic prefix or the sequence of sample symbols modulated with the pseudo random sequence; and
estimate a channel from the ranging measurement frame based at least in part on the channel estimation technique.

29. The apparatus of claim 28, wherein the zeroed-out cyclic prefix comprises a gap interval, a set of zero-value-modulated symbols, no transmission, or an unmodulated carrier, or any combination thereof.

30. The apparatus of claim 28, further comprising instructions stored in the memory and executable by the processor to cause the apparatus to:
model the channel as a finite impulse response (FIR) filter; and
determine a system of equations based at least in part on the FIR filter.
